(19) United States
(12) Patent Application Publication
(10) Pub. No.: US 2026/0135735 A1
(43) Pub. Date: May 14, 2026

(54) METHOD AND SYSTEM OF PERFORMING INTEGRATED SENSING AND COMMUNICATION

(71) Applicant: L&T TECHNOLOGY SERVICES LIMITED, Chennai (IN)

(72) Inventors: GUDLA VISHNU VARDHAN, Visakhapatnam (IN); RAKESH VASDEV KHEMANI, Bengaluru (IN)

(21) Appl. No.: 19/383,570

(22) Filed: Nov. 7, 2025

(30) Foreign Application Priority Data
Nov. 12, 2024 (IN) 202441087411

(51) Int. Cl. H04L 25/02; H04L 5/00; H04L 27/26

(52) U.S. Cl. CPC H04L 25/022; H04L 5/0048; H04L 27/2646

(57) ABSTRACT

System and a method of performing integrated sensing and communication in a wireless communication environment is disclosed. Communication signals transmitted from transmitter antennas are received by receiver antennas of a base station via a plurality of channel paths caused by a plurality of the targets in the environment. Delay and weighted Doppler-shift of pilots for the channel paths are determined. Weighted doppler-shifts for the channel paths are determined as weighted average of a set of integer Doppler positions of the received pilots. Total Doppler-shift and total delay of receiver antenna are determined as average of the weighted Doppler-shifts and the delays respectively. Final Doppler-shift and final delay of the channel paths are determined as average of total Doppler-shifts and total delays of the receiver antennas. Bistatic range and relative velocity are determined based on the final Doppler-shift and final delay.

### TECHNICAL FIELD

The disclosure generally relates to wireless communication, and more particularly to a method and system of performing integrated sensing and communication.

### BACKGROUND

In wireless communication, signals may change their characteristics during propagation due to environmental factors. Radio sensing allows identifying clients, devices, and objects in the environment, e.g., to localize uncontrolled sources of interference to avoid or nullify them. Conventionally, communication and sensing systems were enabled separately due to their different design objectives. Existing integrated sensing and communication (ISAC) systems are not spectrum and hardware efficient as they fall short due to challenges in designing signals that effectively balance both communication and sensing functions. Thus, conventional sensing and communication systems are typically designed separately and operate within distinct frequency bands.

Therefore, there is a need to implement sensing and communication systems simultaneously for dual usage of spectrum and high data rates.

### SUMMARY OF THE INVENTION

In an embodiment, a method of performing integrated sensing and communication in a wireless communication environment is disclosed. The method may include receiving, by a plurality of receiver antennas of a base station (BS), communication signals transmitted from a plurality of transmitter antennas. Each of the communication signals may be received via a plurality of channel paths caused by a plurality of targets in the wireless communication environment. Each of the communication signals may include a plurality of pilots each uniquely corresponding to a transmitter antenna of the plurality of transmitter antennas. The method may include, for each of the plurality of channel paths and for each of the plurality of receiver antennas, determining weighted Doppler-shifts and delays of each of the plurality of pilots in each of the received communication signals based on representation of the received communication signals in a delay-Doppler domain. The weighted Doppler-shifts of each of the plurality of pilots may be determined based on a weighted average of a set of Doppler values corresponding to a set of integer Doppler positions of each of the plurality of pilots. Further, for each of the received communication signals by each of the plurality of receiver antennas, the method may include, determining, by the BS, a total Doppler shift for a corresponding receiver antenna from the plurality of receiver antennas based on an average of the corresponding weighted Doppler-shifts determined of each of the plurality of pilots received by the corresponding receiver antenna via each of the plurality of channel paths. Further, for each of the received communication signals by each of the plurality of receiver antennas, the method may include, determining, by the BS, a total delay for the corresponding receiver antenna based on an average of the corresponding delays determined of each of the plurality of pilots received by the corresponding receiver antenna via each of the plurality of channel paths. Further, the method may include determining, by the BS, a final Doppler shift of each of the plurality of channel paths as an average of the total Doppler shifts determined for each of the plurality of channel paths and for each of the plurality of receiver antennas. Further, the method may include determining, by the BS, a final delay of each of the plurality of channel paths as an average of the total delays determined for each of the plurality of channel paths and for each of the plurality of receiver antennas. The method may further include determining, by the BS, a bistatic range and a relative velocity of each of the plurality of targets based on the final Doppler shift and the final delay of each of the plurality of channel paths and of the plurality of receiver antennas and a channel matrix and angle of arrivals of each of the received communication signals.

In another embodiment, a wireless communication system for performing integrated sensing and communication is disclosed. The system may include a base station (BS) that may further include a plurality of receiver antennas. The base station (BS) may be configured to receive, via the plurality of receiver antennas, communication signals transmitted by a plurality of transmitter antennas. Each of the communication signals are received via a plurality of channel paths caused by a plurality of targets. Further, each of the received communication signals may include a plurality of pilots uniquely corresponding to the plurality of transmitter antennas. For each of the plurality of channel paths and for each of the plurality of receiver antennas, the BS may be further configured to determine a weighted Doppler-shift and a delay of each of the plurality of pilots in each of the received communication signals based on representation of the received communication signals in a delay-Doppler domain. It is to be noted that the weighted Doppler-shift of each of the plurality of pilots is determined based on a weighted average of a set of Doppler values corresponding to a set of integer Doppler positions of each of the plurality of pilots. For each of the received communication signals by each of the plurality of receiver antennas, the BS may be configured to determine a total Doppler shift for a corresponding receiver antenna from the plurality of receiver antennas based on an average of the corresponding weighted Doppler-shifts determined of each of the plurality of pilots received by the corresponding receiver antenna via each of the plurality of channel paths. Further, for each of the received communication signals by each of the plurality of receiver antennas the BS may be configured to determine a total delay for the corresponding receiver antenna based on an average of the corresponding delays determined of each of the plurality of pilots received by the corresponding receiver antenna via each of the plurality of channel paths. Further, the BS may be configured to determine a final Doppler shift of each of the plurality of channel paths as an average of the total Doppler shifts determined for each of the plurality of channel paths and for each of the plurality of receiver antennas. Further, the BS may be configured to determine a final delay of each of the plurality of channel paths as an average of the total delays determined for each of the plurality of channel paths and for each of the plurality of receiver antennas. The BS may be configured to determine a bistatic range and a relative velocity of each of the plurality of targets based on the final Doppler-shifts and the final delays of each of the plurality of channel paths and of the plurality of receiver antennas and a channel matrix and angle of arrivals of each of the received communication signals.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a schematic diagram of an exemplary wireless communication environment 100, in accordance with an embodiment of the present disclosure.

FIG. 2A, FIG. 2B, FIG. 2C and FIG. 2D illustrate a schematic of exemplary data frames in delay-Doppler (DD) domain of communication signals transmitted by each of the plurality of the transmitter antennas, in accordance with some embodiments of the present disclosure.

FIG. 3 illustrates an exemplary data frame comprising symbols of the communication signal received by one of the plurality of receiver antennas based on the transmission of the exemplary data frames of FIGS. 2A-2D.

FIG. 4 illustrates a functional block diagram of various modules of the base station for detecting a plurality of targets in wireless communication environment, in accordance with an embodiment of the present disclosure.

FIG. 5 illustrates a graph depicting a plot for possible Angle of arrivals (AoA) vs noise spatial spectrum, in accordance with an embodiment of the present disclosure.

FIG. 6 illustrates a flow diagram depicting methodology of detecting a plurality of targets in wireless communication environment, in accordance with an embodiment of the present disclosure.

FIG. 7A and FIG. 7B illustrates a detailed flow diagram of estimating channel characteristics of plurality of channel paths in wireless communication environment, in accordance with an embodiment of the present disclosure.

FIG. 8 illustrates a flow diagram depicting methodology of sensing targets in the wireless communication environment based on channel estimation as described in flow diagram of FIG. 7A and FIG. 7B.

FIG. 9 illustrates an exemplary table depicting a plurality of simulation parameters and their estimated values to evaluate performance of channel estimation using the methodology of present disclosure with respect to actual channel.

FIG. 10 illustrates a graph depicting a plot of normalized mean squared error (NMSE) of the estimated channel vs. signal to noise ratio (SNR) graph determined based on simulation parameters of FIG. 9.

FIG. 11 illustrates an exemplary table depicting estimated target parameters for each of the plurality of channel paths, in accordance with the embodiments of FIG. 9.

FIG. 12A illustrates a graph representing root mean square error (RMSE) of bistatic range vs. SNR, in accordance with the embodiments of FIG. 11.

FIG. 12B illustrates a graph representing root mean square error (RMSE) of relative velocity vs. SNR, in accordance with the embodiments of FIG. 11.

FIG. 12C illustrates a graph depicting average bit error rate (ABER) vs. SNR, in accordance with the embodiments of FIG. 11.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementation are possible without departing from the scope of the disclosed embodiments. It is intended that the following detailed descriptions be considered exemplary only, with the true scope being indicated by the following claims. Additional illustrations are listed.

Further, the phrases “in some embodiments”. “In accordance with some embodiments”, “in the embodiments shown”, “in other embodiments”, and the like mean a particular feature, structure, or characteristic following the phrase is included in at least one embodiment of the present disclosure and may be included in more than one embodiment. In addition, such phrases do not necessarily refer to the same embodiments or different embodiments. It is intended that the following detailed description be considered exemplary only, with the true scope being indicated by the following claims.

Ranges can be expressed herein as from “about” one particular value, and/or “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

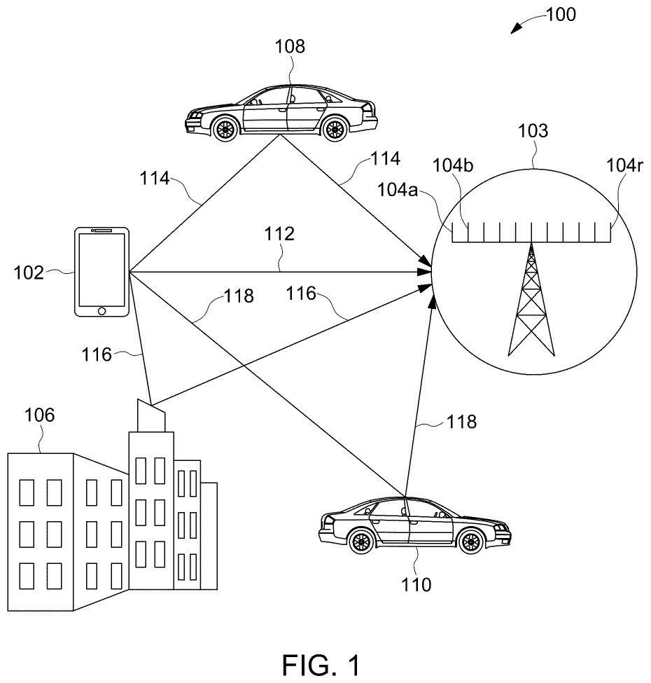

Reference will now be made to the exemplary embodiments of the disclosure, as illustrated in the accompanying drawings. Wherever possible, same numerals have been used to refer to the same or like parts. The following paragraphs describe the present disclosure with reference to FIG. 1-12C. As summarized above, in one broad aspect, the present invention provides a method of performing integrated sensing and communication in wireless communication environment. Due to evolution of technologies such as millimetre waves, terahertz, and multi-input multi-output (MIMO), communication signals in high-frequency bands typically exhibit high resolution in both the time and angular domains that may allow sensing based on estimation of channel characteristic of the communication signals as will be discussed in more detail below.

FIG. 1 is a schematic diagram illustrating an exemplary wireless communication environment 100, in accordance with an embodiment of the present disclosure. The wireless communication environment 100 may include a user equipment (UE) 102 and a base station (BS) 103. It is to be noted that the UE 102 may include one or more transmitter antennas 102a-n (not shown), and the BS 103 may include one or more receiver antennas 104a-r. The UE 102 may transmit a communication signal from each of the one or more transmitter antennas 102a-n that may be received by each of the one or more receiver antennas 104a-r. As can be seen in FIG. 1, the environment 100 in which the UE 102 and the BS 103 are located also includes one or more stationary targets 106 and moving targets 108, 110. Further, communication signal may propagate from the UE 102 to the one or more receiver antennas 104a-r via the line-of-sight (LOS) path 112 and non-line-of-sight (NLOS) paths 114, 116 and 118 by being reflected from the one or more stationary targets 106 and the moving targets 108, 110. Thus, the LOS paths 112 and the NLOS paths 114, 116, 118 between the UE 102 and the plurality of receiver antennas 104a-r may form a plurality of channel paths (P) caused by the one or more stationary targets 106 and the moving targets 108, 110. Characteristics of the wireless channel paths (P) between the UE 102 and the BS 103 may be determined by performing channel estimation. Accurate channel estimation is not only important for reliable and efficient communication it may also be utilized for detecting and sensing the targets in the environment 100 as discussed in greater detail below. Channel characteristics may include determination of following parameters for each of the plurality of paths: Delay of the Pth path (τₚ), Doppler shift of the Pth path (νₚ), Channel gain of the Pth path (hₚ), Angle of Arrival (AoA) of the Pth path, (θₚ) and Angle of Departure (AoD) of the Pth path (φₚ), etc.

According, to 3GPP TS 22.137 V19.1.0 (2024 March), (still awaiting official approval from Technical Specification Group (TSG) and 3GPP TR 21.905 [1]) the data derived from 3GPP radio signals impacted (e.g., reflected, refracted, diffracted) by an object or target in the wireless communication environment may be utilized for sensing purposes, and processed within the communication system. Further, the processing of communication signals provide capabilities to get information about characteristics of the environment and/or targets within the environment (e.g., shape, size, orientation, speed, location, distances or relative motion between objects, etc) using new radio (NR) radio frequency signals, which, in some cases, can be extended by information created via previously specified functionalities in enhanced packet core (EPC) and/or evolved UMTS terrestrial radio access network (E-UTRAN). Further, sensing assistance information, map information, area information, a UE ID attached to or in the proximity of the sensing target, UE position information, UE velocity information etc. may be utilized for further tracking the targets with respect to the UE. Thus, the channel characteristics of the communication signals may be utilized in wireless sensing by acquiring information about characteristics of the environment and/or targets within the environment 100, that uses radio frequency to determine the distance (range), angle, or instantaneous linear velocity of objects, etc. Additionally, range, velocity, and angle information from the radio frequency signals can also be obtained to provide a broad range of new functionality, such as various objects detection, object recognition (e.g., vehicle, human, animal, UAV) and high accuracy localization, tracking and activity recognition.

The present disclosure provides processing of the communication signals in the delay-Doppler (DD) domain using Orthogonal Time Frequency Space (OTFS) modulation because it effectively allows analysis of the combined effects of delay and Doppler shift, especially in high-mobility scenarios where traditional methods struggle with rapidly changing channel conditions as depicted by environment 100. Thus, communication signals when processed in the delay-Doppler (DD) domain may provide superior performance compared to processing in just the time or frequency domain alone. In an embodiment, communication signals in time-frequency domain (Orthogonal frequency-division multiplexing (OFDM) signals) may be represented in the delay-Doppler domain (OTFS modulated signals) using symplectic finite Fourier transform (SFFT) of the OFDM signals. In an embodiment, the SFFT includes performing fast Fourier transform (FFT) to represent time as Doppler-shift and performing inverse fast Fourier transform (FFT) to represent frequency as delay. Accordingly, communication signals in OTFS can represent the channel as a sparse matrix, simplifying channel estimation and equalization while mitigating the impact of multipath propagation and Doppler spread while processing. According to the current disclosure, the communication signals as transmitted by each of the transmitter antennas may include a plurality of data frames comprising symbols that may include a pilot and data as described in detail in below.

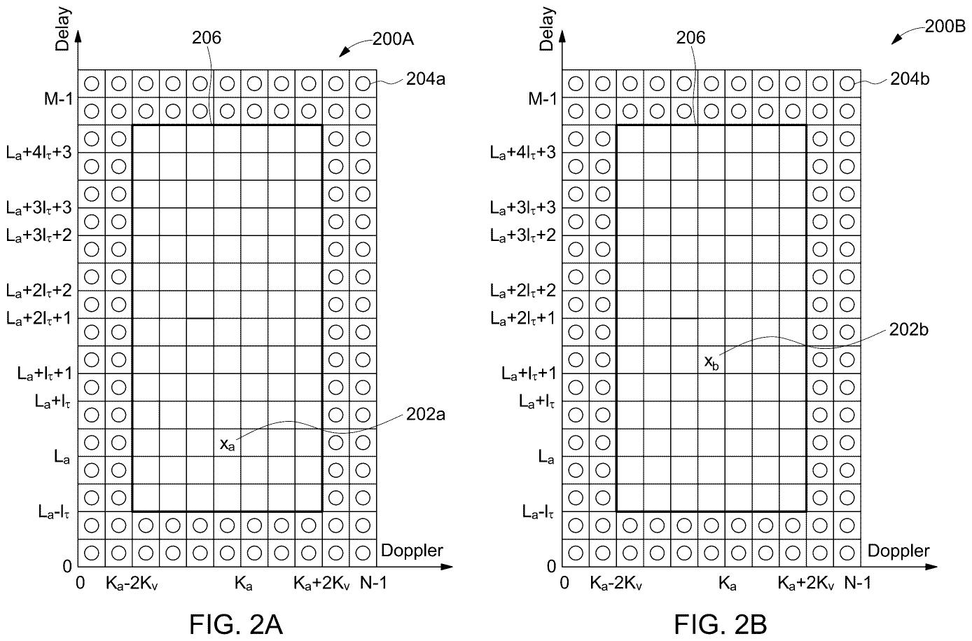

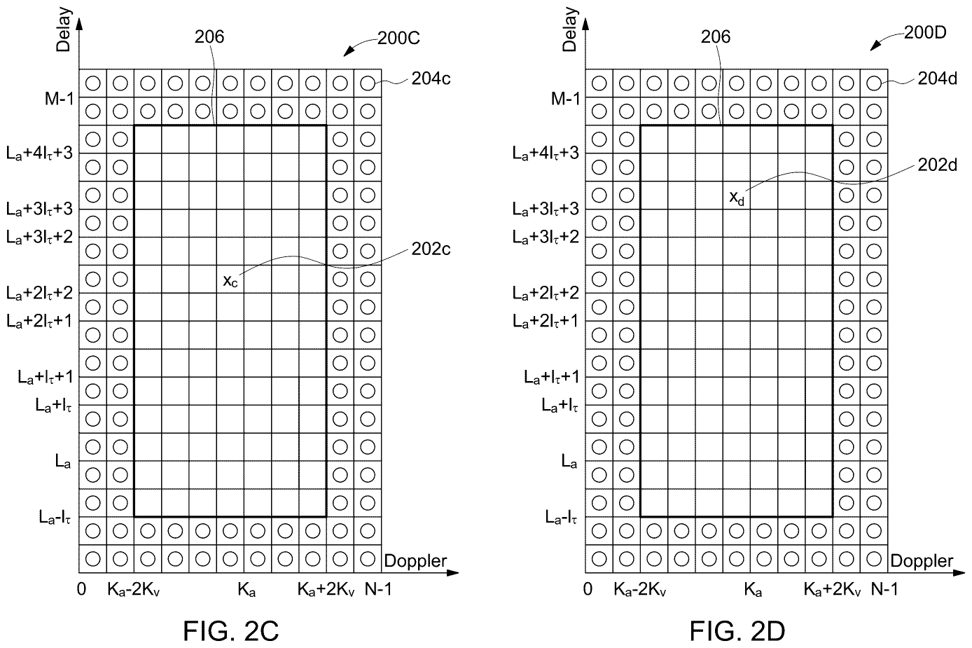

FIG. 2A, FIG. 2B, FIG. 2C and FIG. 2D illustrate a schematic of exemplary data frames 200A-D in delay-Doppler (DD) domain of communication signals transmitted by each of the plurality of the transmitter antennas 102a-d, in accordance with an embodiment of the present disclosure. It is to be noted that each of the transmitter antennas 102a-n may transmit the exemplary data frames 200A-N. Also, each of the exemplary data frames 200A-N transmitted by each of the plurality of the transmitter antennas 102A-N may include symbols such as a pilot 202a-n along with data 204a-n. For ease of explanation and depiction we assume that there are four transmitter antenna 102a-d. However, the number of transmitter antennas may not be limited to four and may vary based on implementation and design choice. As shown in FIG. 2A, the data frame is represented in delay-Doppler domain with x-axis representing Doppler values and the y-axis represents delay values. Further, if there are ‘N’ time slots each of duration ‘T’ and ‘M’ number of sub-carriers with subcarrier spacing ‘Δf’ according to OFDM, then delay unit resolution (τᵣₑₛ) or a delay bin to compute delay values represented by the y-axis is 1/MΔf and Doppler shift unit resolution (νᵣₑₛ) or Doppler bin to compute Doppler shift values represented by the x-axis is 1/NT in accordance with the OTFS modulation. It is to be noted that the unit resolution value is the minimum value that can be represented in the DD domain. The each of the transmitted communication signals, may be a sequence of symbols divided into N_{T} parallel data streams each of the same size MN×1 and arranged in two-dimensional DD grid of M rows and N columns. The vector notation of the DD signal is represented by equation (1) below:

$${x}_{i}^{DD} , i = 1 , 2 , … , {N}_{T} \qquad ( 1 )$$

Further, according to the OTFS modulation (including inverse symplectic finite Fourier transform (ISFFT) and Heisenberg transform), the baseband time domain signal (sᵢ) represented by equation (2) below may be represented as equation (3) mentioned below:

$${s}_{i} ∈ {C}^{MN \times 1} \qquad ( 2 )$$

$${s}_{i} = ( {F}_{N}^{H} ⊗ {I}_{M} ) {x}_{i}^{DD} \qquad ( 3 )$$

Wherein F_{N} is FFT matrix of size (N×N) and
I_{M} is Identity matrix of size (M×M)

Total time domain signal of size MN×N_{T} with respect to plurality of transmitter antennas may be represented as a matrix of equation (4) and (5) mentioned below:

$$S ∈ {C}^{MN \times {N}_{T}} \qquad ( 4 )$$

$$S = ( {F}_{N}^{H} ⊗ {I}_{M} ) {X}_{DD} \qquad ( 5 )$$

$$wherein {X}_{DD} = [ {x}_{1}^{DD} , {x}_{2}^{DD} , … , {x}_{{N}_{T}}^{DD} ] ∈ {C}^{MN \times {N}_{T}}$$

is the DD domain transmit symbol matrix.

Further, we may obtain time domain symbol matrix in vector notation of size N_{T}MN×1 of equation (5.1) below:

$$s = vec \{ S \} = ( {I}_{{N}_{T}} ⊗ ( {F}_{N}^{H} ⊗ {I}_{M} ) {x}_{DD} \qquad ( 5.1 )$$

$$Wherein {x}_{DD} = {[ {( {x}_{1}^{DD} )}^{H} , {( {x}_{2}^{DD} )}^{H} , … , {( {x}_{{N}_{T}}^{DD} )}^{H} ]}^{H}$$

is the vectorized DD domain symbol vector of length N_{T}MN. This time domain symbol vector is transmitted through the plurality of transmitter antennas 102a-n.

Each of the pilots 202a-d may uniquely correspond to each of the plurality of the transmitter antennas 102a-d. Further each of the pilots 202a-d may be located at a predefined positions (P_{a-d}) in a guard interval 206 of the exemplary data frames 200A-D of the communication signal. It is to be noted that each of the pilots 202a-d in the guard interval 206 may uniquely correspond to each of the plurality of transmitter antennas 102a-d based on the predefined positions (P_{a-d}). Thus, each transmitter antenna 102 may transmit a unique pilot 202 at a unique position ‘P’ in the guard interval 206 in order to uniquely correspond to the corresponding transmitter antenna 102.

As shown in FIG. 2A, each of the exemplary data frames 200A-D have a guard interval 206 that may extend for a predefined area for example (Kₐ−2k_{ν}, Lₐ−l_{τ}) to (Kₐ+2k_{ν}, Lₐ+4l_{τ}+3), wherein l_{τ} and k_{ν} are the maximum delay and Doppler shift experienced by the BS based on previous observations. The exemplary data frame 200A depicts a pilot symbol (Xₐ) 202a at position Pₐ (Kₐ, Lₐ) and data (O) 204a in the delay-Doppler (DD) domain as transmitted by transmitter antenna 102a. Similarly, FIG. 2B, FIG. 2C and FIG. 2D depict the exemplary data frames 200B, 200C and 200D respectively including the arrangement of a pilot symbols (X_{b}, X_{c}, . . . X_{d}) 202b-d at positions Pb, Pc, Pd respectively. The pilot symbols (X_{b}, X_{c}, . . . X_{d}) 202b-d are provided in the corresponding guard interval 206 along with corresponding data (O) 204b-d in the corresponding data frames 200B, 200C and 200D respectively as transmitted by the transmitter antennas 102b-d respectively.

Referring now to FIG. 1 again, the exemplary data frame 200A of the communication signal as depicted in FIG. 2A when received at each of the plurality of receiver antennas 104a-r. The exemplary data frame 200A may be received via a plurality of channel paths 112-118 created due to the targets 106-110 in the communication environment 100. Thus, communication signals transmitted from each of the transmitter antennas 102a-n may be received by each of the receiver antennas 104a-r via each of the plurality of channel paths 112-118 caused by the targets 106-110.

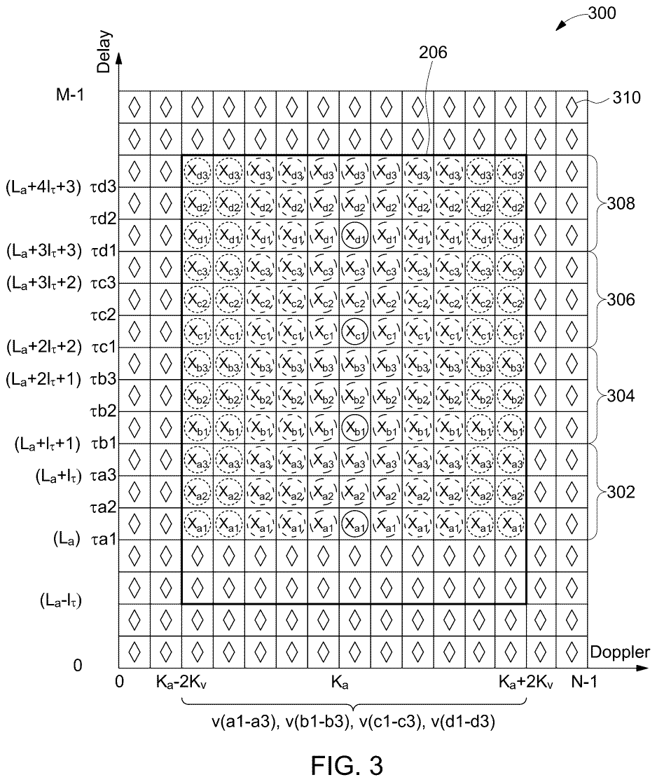

FIG. 3 illustrates an exemplary data frame comprising symbol 300 of the communication signal received by one of the plurality of receiver antennas 104a-r based on the transmission of the exemplary data frames 200A-D of FIGS. 2A-2D. The exemplary communication signal may be received via the plurality of channel paths (p₁₋₃) 112-118 created due to the targets 106-110 in the environment 100. As can be seen in FIG. 3, the received data frame 300 includes data 204a-d and pilots Xa₁-Xa₃, Xb₁-Xb₃, Xc₁-Xc₃, and Xd₁-Xd₃ corresponding to pilots 202a-d transmitted by each of the transmitter antennas 102a-d and via each of the channel paths p₁₋₃. Accordingly, Xa₁-Xa₃ correspond to pilot 202a that has been transmitted via each of the channel paths p₁₋₃. Similarly, Xb₁-Xb₃, Xc₁-Xc₃, and Xd₁-Xd₃ correspond to the pilots 202b-d transmitted via each of the channel paths p₁₋₃.

It is to be noted that during transmission the communication signal via the plurality of channel paths 112-118, there is change in signal frequency due to movement of targets in wireless communication environment, delay in transmission and attenuation of the communication signal. This may be characterized as spread of the data 204a-d and the pilots 202a-d across the x-axis and y-axis i.e., across the delay and Doppler values in the DD domain. The spread of each of the pilot 202a-n across a number the delay positions (τₐ₁₋ₐ₃, τ_{b1-b3}, τ_{c1-c3}, τ_{d1-d3}) may be accounted as a number of channel paths p₁₋₃ through which the signals were transmitted or received at the receiver 104a-r. In FIG. 3, in order to simplify the description, we assume that the received exemplary data frame 300 comprising symbols that includes four pilots Xa₁-Xa₃, Xb₁-Xb₃, Xc₁-Xc₃, and Xd₁-Xd₃ each corresponding to pilots 202a-d each uniquely corresponding to the four transmitter antennas 102a-d. Further, we assume that the received exemplary data frame 300 is received via three channel paths 112-118 caused by the targets 106-110. Hence each of the pilots (Xa₁-Xa₃, Xb₁-Xb₃, Xc₁-Xc₃, and Xd₁-Xd₃) corresponding to pilots 202a-d in the received data frame 300 spreads to three delay values (τ₍ₐ₁₋ₐ₃₎, τ_{(b1-b3)}, τ_{(c1-c3)}, τ_{(d1-d3)}) as seen in areas 302, 304, 306, 308 respectively of the guard interval 206. Further, it can be seen that pilots (Xa₁-Xa₃, Xb₁-Xb₃, Xc₁-Xc₃, and Xd₁-Xd₃) in the received data frame 300 spread to various Doppler positions ν₍ₐ₁₋ₐ₃₎, ν_{(b1-b3)}, ν_{(c1-c3)}, ν_{(d1-d3)} due to the transmission via the plurality of channel paths p₁₋₃. During the transmission of the communication signals via the plurality of channel paths p₁₋₃, the fluctuation in frequency and delay in transmission of the communication signals are attributed as the spread of the pilots (Xa₁-Xa₃, Xb₁-Xb₃, Xc₁-Xc₃, and Xd₁-Xd₃) as depicted in the DD domain. It is to be noted that the spread of the pilots (Xa₁-Xa₃, Xb₁-Xb₃, Xc₁-Xc₃, and Xd₁-Xd₃) due to Doppler shifts that are fractional multiple of the unit resolution of the x-axis cannot be depicted in received DD data frame. This will result in spread of pilots (Xa₁-Xa₃, Xb₁-Xb₃, Xc₁-Xc₃, and Xd₁-Xd₃) to multiple integer Doppler positions. Thus, the spread to Doppler positions that are integer multiple of the unit resolution of the x-axis may be utilized for determination of channel characteristics. Thus, channel estimation of the received communication signal may be performed for each of the receiver antenna 104a-r based on the channel characteristics of the received pilots (Xa₁-Xa₃, Xb₁-Xb₃, Xc₁-Xc₃, and Xd₁-Xd₃) via each of the channel paths p₁₋₃. In order to perform channel estimation, the BS 103 may determine the channel characteristics based on the received exemplary communication signal 300. In an embodiment, the BS 103 may include a processor (e.g. a digital signal processor (DSP) that may enable the BS 103 to perform integrated sensing and communication (ISAC) or joint communication and sensing (JCAS). Further, the BS 103 may perform channel estimation by determining weighted Doppler-shifts and delays of each of the plurality of pilots (Xa-n) in each of the received communication signals for each of the plurality of channel paths p₁₋₃. Further, the BS 103 may determine a total Doppler shift for a corresponding receiver antenna 104a from the plurality of receiver antennas 104a-r based on an average of the corresponding weighted Doppler-shifts determined for each of the plurality of channel paths of the corresponding receiver antenna 104a. Further, the BS 103 may determine a total delay for the corresponding receiver antenna 104a based on an average of the corresponding delays determined for each of the plurality of channel paths p₁₋₃ of the corresponding receiver antenna 104a.

The BS 103 may determine a final Doppler shift of each of the plurality of channel paths P₁₋₃ as an average of the total Doppler shifts determined for each of the plurality of channel paths P₁₋₃ and for each of the plurality of receiver antennas 104a-r. Further, the BS 103 may perform bistatic sensing of the targets to determine relative velocity and bistatic range of each of the targets in the environment 100 based on the channel estimation. The BS 103 may determine a bistatic range and a relative velocity of each of the plurality of targets 106-110 based on the final Doppler shift and the final delay of each of the plurality of channel paths P₁₋₃ and of the plurality of receiver antennas 104a-r and a channel matrix and angle of arrivals of each of the plurality of channel paths P₁₋₃ as described in detail below.

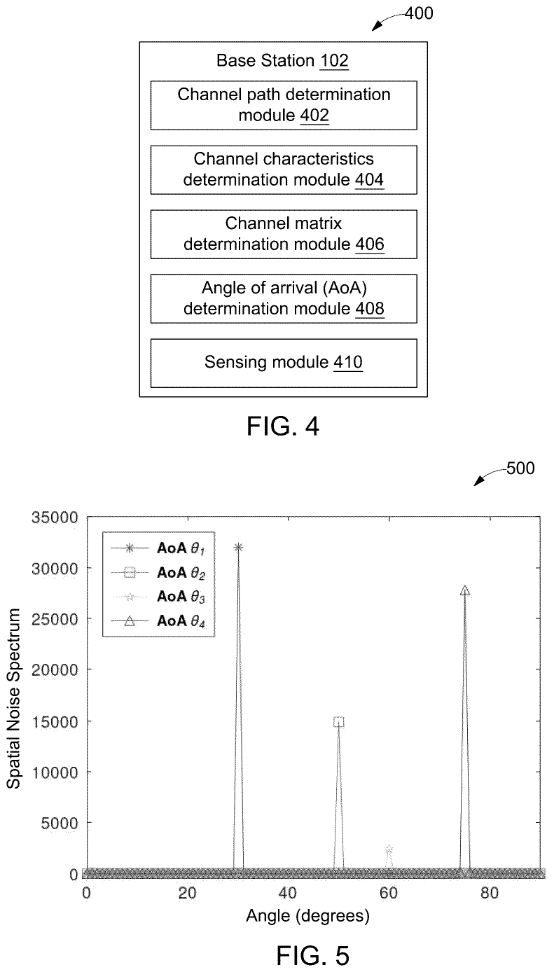

Referring now to FIG. 4 a functional block diagram 400 of various modules of the base station 103 for detecting a plurality of targets in wireless communication environment 100 is illustrated, in accordance with an embodiment of the present disclosure. The BS 103 may include a processor (not shown) that may include one or more modules such as, but not limited to, a channel path determination module 402, a channel characteristics determination module 404, a channel matrix determination module 406, an angle of arrival (AoA) determination module 408 and a sensing module 410. As will be appreciated, description of the FIG. 4 is provided in conjunction with FIGS. 1-3.

Referring to FIG. 3, since the pilot (Xa) corresponding to pilot 202a of the transmitted antenna 102a, when received via the plurality of channel paths P₁₋₃ is received as pilots Xa₁-Xa₃ as shown in the received data frame 300 of the received signal by receiver antenna 104a. Similarly, pilots (Xb-d) corresponding to pilot 202b-d of the transmitted antenna 102b-d, when received via the plurality of channel paths P₁₋₃ are received as pilots (Xb₁-Xb₃, Xc₁-Xc₃, and Xd₁-Xd₃) as shown in the received data frame 300 of the received signal by receiver antenna 104a. Each of the pilots (Xa₁-Xa₃, Xb₁-Xb₃, Xc₁-Xc₃, and Xd₁-Xd₃) are scattered or spread across the x-axis for a range of integer Doppler positions and for each of the delay positions (τa₁₋₃, τb₁₋₃, τc₁₋₃, τd₁₋₃) in areas 302-308. In order to determine a weighted Doppler shift of each of the pilots (Xa₁-Xa₃, Xb₁-Xb₃, Xc₁-Xc₃, and Xd₁-Xd₃), a weighted average of a set of doppler values (νa₁₋₃, νb₁₋₃, νc₁₋₃, νd₁₋₃) corresponding to a set of integer Doppler positions may be determined for each of the channel paths P₁₋₃. It is to be noted that, the set of integer Doppler positions may be determined from a range of integer Doppler positions 206. The range of integer Doppler positions 206 may be determined based on a change in Doppler value of each of the pilots (Xa₁-Xa₃, Xb₁-Xb₃, Xc₁-Xc₃, and Xd₁-Xd₃) with respect to an initial Doppler value corresponding to the predefined positions Pa-d of the pilots 202a-d. Thus, all the integer Doppler positions at which the pilot signals Xa-d are determined as the range of integer Doppler positions. Similarly, weighted Doppler shift of each of the pilots Xa-Xd are also determined for each of the channel paths P₁₋₃.

As discussed earlier, due to attenuation during transmission of the communication signal via the plurality of channel paths 112-118, the pilot 202a frequency may change that may be characterized as the Doppler spread ν_{A1-A3} across the x-axis which would include fractional Doppler values which cannot not be represented or captured in the DD domain as they are fractional multiple of the unit Doppler resolution of the x-axis. Further, the attenuation in signal strength of the pilot 202a is depicted in FIG. 3 using the density of the broken circular lines which decreases at positions away from the predefined position (Xa). Thus, the range of integer Doppler positions are determined as positions on the x-axis which are integer multiple of doppler shift unit resolution 1/NT for which pilots Xa-d are received by the receiver antennas 104a-r.

The transmit data frame comprising pilot, guard band and data symbols may be mathematically represented as delay Doppler grid Xⁿ[k, l] as shown below in equation (6) for n th transmit antenna,

$${X}^{n} [ k , l ] = \{ \begin{matrix}{x}_{n} & k = {K}_{a} , l = {L}_{a} + ( n - 1 ) ( {l}_{τ} + 1 ) \\ 0 & \begin{matrix}{K}_{a} - 2 {k}_{ν} \leq k \leq {K}_{a} + 2 {k}_{ν} , \\ {L}_{a} - {l}_{τ} \leq l \leq {L}_{a} + {N}_{T} {l}_{τ} + {N}_{T} - 1\end{matrix} \\ {x}_{d}^{n} & otherwise\end{matrix} \qquad ( 6 )$$

Wherein Lₐ is normalized delay position or predefined delay position of the pilot 202a and;
Kₐ is normalized Doppler position that is predefined Doppler position of the pilot 202a.

At the r th receive antenna (r=1, . . . , N_{R}), the received data symbols corresponding to pilots in DD domain 300 as depicted in FIG. 3 may be mathematically represented as equation (7) below:

$${Y}^{r} [ k , l ] , 0 \leq k \leq N - 1 , {L}_{a} + ( n - 1 ) ( {l}_{τ} + 1 ) \leq l \leq {L}_{a} + {nl}_{τ} + n - 1 \qquad ( 7 )$$

As will be appreciated the computation of delay τₐ₁₋ₐ₃ and Doppler shift ν₍ₐ₁₋ₐ₃₎ of each of the plurality of channel paths P₁₋₃ via pilot 202a that is transmitted by transmitter antenna 102a is explained for simplification of understanding.

The received data frames 300 may be used for channel estimation corresponding to the nth transmit antenna based on weighted minimum mean square error (MMSE) technique.

The received signal vector y_{DD} of size N_{R}MN×1 is rearranged as matrix given in equation (8) of size MN×N_{R} in such a way that data frames corresponding to each receiver antenna 104a-r are stacked column wise.

$${\tilde{Y}}_{DD} = [ {y}_{1} , {y}_{2} , … , {y}_{{N}_{R}} ] \qquad ( 8 )$$

Each yᵣ, r∈[1, 2, . . . , N_{R}] column from \tilde{Y}_{DD} can reshaped into matrix Y^{r}[k, l] of size M×N that contains received pilot symbols Xa-d corresponding to each transmitter antenna 102a-d at locations 0≤k≤N−1, Lₐ+(n−1)(l_{τ}+1)≤l≤Lₐ+nl_{τ}+n−1 that includes the range of integer Doppler locations for different delay locations. Channel estimation is performed to obtain channels between nth transmit antenna 102 and each of the rth receiver antennas 104a-r.

The channel path determination module 402 may determine a number of channel paths based on which the communication signals transmitted from the plurality of transmitter antennas 102a-n are received by each of the plurality of receiver antennas 104a-r. In accordance with the exemplary embodiments of the FIGS. 1-3, the number of plurality of channel paths depend upon a number of non-line of sight paths caused by the targets and line of sight path between UE and BS in the environment 100. Further, the number of plurality of channel paths may be determined based on determination of a number of delay positions or bins to which a pilot 202a-d has spread in the received signal 300. According, to the exemplary embodiment of FIG. 3, the number of channel paths may be assumed as ‘3’ as each of the pilots 202a-d are received at three delay positions (τa₁₋₃, τb₁₋₃, τc₁₋₃, τd₁₋₃) as seen in areas 302, 304, 306, 308 respectively of the guard interval 206 in the received data frame 300 with respect to their initial predefined positions (Xa-d) in the transmitted data frames 200A-D. For example, in the received data frame 300, the pilot 202a is received at three delay positions τa₁₋₃ in area 302 of the guard interval 206.

Further, the channel characteristics determination module 404 may determine delays of each of the plurality of pilots (Xa₁-Xa₃, Xb₁-Xb₃, Xc₁-Xc₃, and Xd₁-Xd₃) for each of the plurality of channel paths P₁₋₃ in the received signal 300 by the receiver antenna 104a as the delay positions (τa₁₋₃, τb₁₋₃, τc₁₋₃, τd₁₋₃) based on representation of the received communication signals in the delay-Doppler domain. Further, the channel characteristics determination module 404 may determine a total delay for the corresponding receiver antenna 104a based on an average of the corresponding delays determined for each of the plurality of channel paths of the corresponding receiver antenna 104a. In an example, a total delay τaₚ₁ for path P₁ of receiver antenna 104a may be determined as an average of the delays τa₁, τb₁, τc₁, τd₁. Similarly, total delays τap₂ and τap₃ for paths P₂₋₃ of receiver antenna 104a may be determined as average of delays τa₂, τb₂, τc₂, τd₂ and τa₃, τb₃, τc₃, τd₃ respectively. Further, a final delay τp₁ path P₁ and for each of the plurality of receiver antennas 104a-r may be determined as an average of total delays τap₁-τrp₁ determined for paths P₁ for each of the plurality of receiver antennas 104a-r. Similarly, final delays τp₂ and τp₃ for each of the paths P₂₋₃ and for each of the plurality of receiver antennas 104a-r may be determined as an average of total delays τap₂−τrp₂ and τap₃−τrp₃ determined for paths P₂ and P₃ for each of the plurality of receiver antennas 104a-r.

In order to determine final Doppler shift of each of the plurality of channel paths P₁₋₃ for communication signals received by each of the plurality of receiver antenna 104a-r, the delay and Doppler determination module 406 may determine a weighted Doppler shift of each of the pilots 202a-d in the received communication signal for each of the plurality of channel paths P₁₋₃ and for each of the plurality of receiver antennas 104a-r.

For simplification of understanding, determination of weighted Doppler-shifts of pilot 202a in the received communication signal received by the receiver antenna 104a via each of the plurality of channel paths P₁₋₃ is explained. As shown in FIG. 3, pilot 202a located at (Kₐ, Lₐ) due to transmission via the channel paths P₁₋₃ is spread integer Doppler positions: Y^{r} (k, l), 0≤k≤N−1, Lₐ≤l≤Lₐ+l_{τ}.

Further, the channel characteristics determination module 406 may determine a range of integer Doppler positions as the integer Doppler positions, where pilot 202a is shifted due to channel paths P₁₋₃, for which signal power of pilot 202a is determined greater than a predefined threshold power.

Hence, we compare signal power of the pilot Xa₁-3 received in the range of integer Doppler positions, i.e., from Kₐ−k_{ν}≤k≤Kₐ+k_{ν} & Lₐ≤l≤Lₐ+l_{τ} with a predefined threshold δ, which is considered as 3σₙ, where on is received signal's noise variance. It is to be noted that, l is the delay index, k is the Doppler shift index, and l_{τ} and k_{ν} is Maximum delay and Doppler shift experienced by the base station 104 based on historical channel estimation performed previously.

The channel path determination module 402 may determine whether an individual path with given delay and Doppler taps exists, by determining if a pilot is spread to different delay locations compared to predefined pilot bin lₐ that indicates delay of a channel path. If pilot is not spread to different delay location it indicates it is LOS path between UE and BS. Thus, we estimate whether there exists at least one path within a given delay tap using equations (9) and (10) below.

$${\tilde{b}}_{p} ( l - {L}_{a} ) = \{ \begin{matrix}1 & {\sum }_{{k}^{′} = 0}^{N - 1} b ( {k}^{′} - {K}_{a} , l - {L}_{a} ) \geq 1 \\ & 0 otherwise\end{matrix} \qquad ( 9 )$$

$${\hat{τ}}_{p} = l - {L}_{a} \qquad ( 10 )$$

Here, b is assigned value of 1 if there a pilot at a particular delay index and Doppler shift index within the guard interval. \tilde{b} may be assigned a value of ‘1’ if there exists a pilot at one or more Doppler positions for a given lth integer Doppler positions. Otherwise, a value of ‘0’ may be assigned. Here, \hat{τ}ₚ is the estimated delay of the Pth path.

The number of detected paths can be calculated as equation (11) below:

$$\hat{P} = {\sum }_{{l}^{′} = {L}_{a}}^{{L}_{a} + {l}_{τ}} {\tilde{b}}_{p} ( {l}^{′} - {L}_{a} ) \qquad ( 11 )$$

In order to determine weighted Doppler-shift for each of the plurality of channel paths, weights of each of the range of integer doppler positions ν₍ₐ₁₋ₐ₃₎, ν_{(b1-b3)}, ν_{(c1-c3)}, ν_{(d1-d3)} may be determined. Further, weights of each of the range of integer Doppler positions may be determined based on a ratio of the signal power of the pilot 202a received for a corresponding integer Doppler position and a norm or normalized value of the signal power of the pilot 202a received for each of the range of predefined integer Doppler positions.

Thus, for each l∈{Lₐ, Lₐ+1, . . . , Lₐ+l_{τ}}, assign weights to each of the range of integer Doppler positions k∈{0,1, N−1}. The normalized absolute value of the received signal at all Doppler positions are considered as weights for the range of predefined integer doppler positions as calculated using equation (12) below.

$${w}_{i}^{l} = \frac{{Y}^{r} ( i , l )}{‖ {Y}^{r} ( 0 : N - 1 , l ) ‖} , i ∈ \{ 0 , 1 , 2 … , N - 1 \} \qquad ( 12 )$$

It is to be noted that

$${w}_{i}^{l}$$

is weight of ith Doppler position along lth delay position. Y^{r} indicates received pilot signal vector at a corresponding receiver antenna of the plurality of receiver antennas 104a-r.

Norm of received pilot signal vector for/th delay position considering all Doppler shifts value from 0 to N−1 may be calculated using equation (13) below.

$$‖ {Y}^{r} ( 0 : N - 1 , l ) ‖ \qquad ( 13 )$$

The weights calculated for each of the range of integer Doppler positions ν₍ₐ₁₋ₐ₃₎, ν_{(b1-b3)}, ν_{(c1-c3)}, ν_{(d1-d3)} at particular delay value l, depicted as:

$${w}^{l} = \{ {w}_{0}^{l} , {w}_{I}^{l} , … , {w}_{N - 1}^{l} \} ,$$

are arranged in descending order to obtain

$$\{ {w}_{{α}_{0}}^{l} , {w}_{{α}_{1}}^{l} , … , {w}_{{α}_{N - 1}}^{l} \}$$

based on equation (14) below.

$$[ {α}_{0} , {α}_{1} , … , {α}_{N - 1} ] = arg sort ( {w}^{l} , ‘ descend ’ ) \qquad ( 14 )$$

Here α₀ and α_{N-1} denotes indices of maximum and minimum weights respectively.

It is to be noted that since each of the pilots Xa₁₋₃, Xb₁₋₃, Xc₁₋₃ and Xd₁₋₃ received are spread along the Doppler axis (x-axis), the amplitude of the received pilot signal reduces as we move further away from the predefined pilot doppler positions Xa₁. Xd₁ of the pilots 202a-d. In an embodiment, a predefined number of integer positions from the range of integer Doppler positions are selected that have the maximum weights. For example, four positions with maximum weights

$${w}_{{α}_{0}}^{l} , {w}_{{α}_{1}}^{l} , {w}_{{α}_{2}}^{l} , {w}_{{α}_{3}}^{l}$$

may be selected to calculate weighted Doppler-shift. Thus, the weighted Doppler-shift of the selected predefined number of positions from the set of integer Doppler positions may be calculated using equation (15) below.

$${\hat{v}}_{p} = \frac{{w}_{{α}_{0}}^{l} {α}_{0} + {w}_{{α}_{1}}^{l} {α}_{1} + … + {w}_{{α}_{3}}^{l} {α}_{3}}{{w}_{{α}_{0}}^{l} + {w}_{{α}_{1}}^{l} \pm … + {w}_{{α}_{3}}^{l}} - {K}_{a} \qquad ( 15 )$$

Accordingly, weighted Doppler-shifts of each of the pilots Xa₁₋₃-Xd₁₋₃ received by the receiver antenna 104a for each of the channel paths p₁₋₃ are determined. Thus, \hat{ν}xa₁₋₃ may be determined as weighted Doppler-shifts for path p₁₋₃ for pilot Xa based on equation (15).

Similarly, the above computation may be repeated for estimating weighted Doppler-shift \hat{ν}xb₁₋₃, \hat{ν}xc₁₋₃ and \hat{ν}xd₁₋₃ of pilots Xb-d received via the channel paths P₁₋₃ by the receiver antenna 104a. Further, a total Doppler shift for each of the channel paths P₁₋₃ for the receiver antenna 104a may be determined as an average of the corresponding weighted doppler shifts determined for each of the channel paths for each of the pilots Xa-d. For example, a total Doppler-shift \hat{ν}ra₁ for channel path P₁ for receiver antenna 104a may be determined as an average of weighted Doppler-shift \hat{ν}xa₁, \hat{ν}xb₁, \hat{ν}xc₁ and \hat{ν}xd₁. Similarly, total Doppler-shifts \hat{ν}ra₂ and \hat{ν}ra₃ for channel paths P₂ and P₃ for receiver antenna 104a may be determined as an average of weighted Doppler-shift \hat{ν}xa₂, \hat{ν}xb₂, \hat{ν}xc₂, \hat{ν}xd₂ and \hat{ν}xa₃, \hat{ν}xb₃, \hat{ν}xc₃, \hat{ν}xd₃ respectively. Similarly, total Doppler-shifts \hat{ν}rb₁₋₃-\hat{ν}rr₁₋₃ for each of the channel paths P₁₋₃ for each of the receiver antennas 104b-r may be determined. Further, a final Doppler-shift \hat{ν}₁ of path P₁ may be determined as an average of the total Doppler shifts \hat{ν}ra₁-\hat{ν}rr₁ determined for each of the plurality of receiver antennas 104a-r. Similarly, final Doppler-shifts \hat{ν}₂ and \hat{ν}₃ of paths P₂ and P₃ may be determined as an average of the total Doppler shifts \hat{ν}ra₂-\hat{ν}rr₂ and \hat{ν}ra₃-\hat{ν}rr₃ determined for each of the plurality of receiver antennas 104a-r. Accordingly, final Doppler-shifts for each of the plurality of channel paths P₁₋₃ may be determined as an average of the total Doppler shifts determined for each of the plurality of channel paths and for each of the plurality of receiver antennas 104a-r by the channel characteristics determination module 404.

The channel matrix determination module 406 may determine channel gain for each of the plurality of channel paths for each of the received signals by each of the plurality of receiver antennas 104. In an embodiment, a linear minimum mean square error (LMMSE) estimation is performed for channel gain estimation. In order to perform channel gain estimation, the received signal vector in DD domain may be expressed as (16) and (17) below.

$${y}_{D D} = {H}_{D D} {X}_{D D} + w \qquad ( 16 )$$

$${y}_{D D} = {\underbrace{\sqrt{{N}_{T} {N}_{R}} [ {\sum }_{p = 1}^{P} {a}_{R} ( {θ}_{p} ) {a}_{T}^{T} ( {φ}_{p} ) ⊗ {H}_{D D}^{p} ]}}_{{H}_{D D}} {x}_{D D} + w \qquad ( 17 )$$

Where H_{DD} is channel matrix in the DD domain; x_{DD}, is the transmit vector in the DD domain; and w is AWGN noise vector; φₚ is Angle of Departure (AoD) of the pth path; θₚ is angle of arrival (AoA) of the Pth path;

a_{R}(θₚ) and a(φₚ) are the received and transmitted array steering vectors of the pth path given by equations (18) and (19) below respectively,

$${a}_{T} ( {φ}_{p} ) = {\sqrt{\frac{1}{{N}_{T}}} [ 1 , {e}^{j π sin {φ}_{p}} , … , {e}^{j π ( {N}_{T} - 1 ) sin {φ}_{p}} ]}^{T} \qquad ( 18 )$$

$${a}_{R} ( {θ}_{p} ) = {\sqrt{\frac{1}{{N}_{R}}} [ 1 , {e}^{j π sin {θ}_{p}} , … , {e}^{j π ( {N}_{R} - 1 ) sin {θ}_{p}} ]}^{T} \qquad ( 19 )$$

Here,

$${H}_{D D}^{p}$$

is the effective delay-Doppler channel for pth path in DD domain that can be expressed as equation (20) below

$${H}_{D D}^{p} = ( {F}_{N} ⊗ {I}_{M} ) {H}_{T}^{p} ( {F}_{N}^{H} ⊗ {I}_{M} ) \qquad ( 20 )$$

Wherein

$${H}_{T}^{p}$$

is effective channel for pth path in time domain, which is expressed as equation (21) below:

$${H}_{T}^{p} = {h}_{p} {π}^{{τ}_{p}} {Δ}^{{v}_{p}} \qquad ( 21 )$$

Here, hₚ is the channel gain of the pth path;

π is the permutation forward cyclic shift matrix

$$π = circ \{ {[ \begin{matrix}0 & 1 & 0 & ... & 0\end{matrix} ]}_{MN \times 1}^{T} \}$$

of size MN×MN; Δ is Diagonal Doppler matrix and may be represented as equation (21.1) below.

$$Δ = diag \{ \begin{matrix}1 & {e}^{j 2 π \frac{1}{MN}} & ... & {e}^{j 2 π \frac{MN - 1}{MN}}\end{matrix} \} \qquad ( 21.1 )$$

τₚ and νₚ are the normalized delay and normalized Doppler shift respectively of the Pth path, which is considered as final delay and final Doppler shift for the plurality of the channel paths.

The received signal corresponding to the pilot 202a can be given by equation (22) below.

$$[ \begin{matrix}{y}_{1} \\ {y}_{2} \\ ⋮ \\ {y}_{{N}_{R}}\end{matrix} ] = [ \begin{matrix}{H}_{11}^{DD} & {H}_{12}^{DD} & … & {H}_{1 {N}_{T}}^{DD} \\ {H}_{21}^{DD} & {H}_{22}^{DD} & … & {H}_{2 {N}_{T}}^{DD} \\ ⋮ & ⋮ & ⋱ & ⋮ \\ {H}_{{N}_{R} 1}^{DD} & {H}_{{N}_{R} 2}^{DD} & … & {H}_{{N}_{R} {N}_{T}}^{DD}\end{matrix} ] + [ \begin{matrix}{x}_{1} \\ {x}_{2} \\ ⋮ \\ {x}_{{N}_{T}}\end{matrix} ] + [ \begin{matrix}{w}_{1} \\ {w}_{2} \\ ⋮ \\ {w}_{{N}_{R}}\end{matrix} ] \qquad ( 22 )$$

It is to be noted that

$${H}_{rn}^{DD}$$

is block submatrix of channel matrix H_{DD} and may be represented as per equation (23) below.

$${H}_{rn}^{DD} = {\sum }_{p = 1}^{P} {h}_{p}^{rn} {γ}_{p} \qquad ( 23 )$$

Where

$${h}_{p}^{rt}$$

is channel gain of the Pth path between tth transmit antenna and rth receive antenna, which includes the effect of AoA and AoD and γₚ is channel path matrix that includes the effect of final delay and final Doppler shift of the Pth path and may be expressed as equations (24) and (25) below respectively.

$${h}_{p}^{rn} = {h}_{p} {e}^{j π ( ( t - 1 ) sin {ϕ}_{p} + ( r - 1 ) sin {θ}_{p} )} \qquad ( 24 )$$

$${γ}_{p} = [ ( {F}_{N} ⊗ {I}_{M} ) {π}^{{τ}_{p}} {Δ}^{{v}_{p}} ( {F}_{N}^{H} ⊗ {I}_{M} ) ] \qquad ( 25 )$$

Based on equations (10) and (14), the estimated final delay \hat{τ}ₚ and final Doppler shift \hat{ν}ₚ for pth path can be used to reconstruct γₚ and the unknown parameter

$${h}_{p}^{rn}$$

may be estimated.

The received signal vector at rth receive antenna can be modified as

$${y}_{r} = {\sum }_{n = 1}^{{N}_{T}} {H}_{rn}^{DD} {x}_{n} \qquad ( 26 )$$

Using equation (23), equation (26) can be modified as equation (27) below.

$${y}_{r} = {\sum }_{n = 1}^{{N}_{T}} ( {\sum }_{p = 1}^{P} {h}_{p}^{rn} {γ}_{p} ) {x}_{n} \qquad ( 27 )$$

The received signal can further be simplified as equation (28) below.

$${y}_{r} = ψ {h}_{r} + {w}_{r} \qquad ( 28 )$$

Where ψ is dictionary matrix and can be expressed as equation (29).

$$ψ = {\underbrace{[ {ψ}_{1} , {ψ}_{2} , .. , {ψ}_{{N}_{T}} ]}}_{MN \times {PN}_{T}} \qquad ( 29 )$$

Wherein each sub-vector of ψ is represented by ψᵢ=[γ₁ xᵢ, γ₂ xᵢ, . . . , γₚ xᵢ], i∈{1, 2, . . . , N_{T}}. Channel gain vector hᵣ for rth receiver antenna 104 can be represented as equation (30) and each sub-vector of hᵣ may be represented as equation (31) mentioned below.

$${h}_{r} = {\underbrace{{[ {h}^{r 1} , {h}^{r 2} , ... , {h}^{{rN}_{T}} ]}^{T}}}_{{PN}_{T} \times 1} \qquad ( 30 )$$

$${h}^{ri} = {\underbrace{{[ {h}_{1}^{ri} , {h}_{2}^{ri} , ... , {h}_{p}^{ri} ]}^{T}}}_{P \times 1} \qquad ( 31 )$$

In general scenario, the received signal corresponding to all receive antennas 104a-r can be represented as equation (32) and (33) below.

$${Y}^{DD} = ψ H + W \qquad ( 32 )$$

$${\underbrace{[ {y}_{1} , {y}_{2 ,} ... , {y}_{{N}_{R}} ]}}_{MN \times {N}_{R}} = {\underbrace{[ ψ ]}}_{MN \times {PN}_{T}} {\underbrace{[ {h}_{1} , {h}_{2} , ... , {h}_{{N}_{R}} ]}}_{{PN}_{T} \times {N}_{R}} + {\underbrace{[ {w}_{1} , {w}_{2} , ... , {w}_{{N}_{R}} ]}}_{MN \times {N}_{R}} \qquad ( 33 )$$

To estimate channel gain corresponding to plurality of pilot signals Xa-d received in yᵣ, a dictionary matrix ψ can be reconstructed based on known pilot signals 202a-d, their locations in DD domain and, estimated delay and final Doppler shift of channel paths p₁₋₃ using equations (10) and (15).

Using estimated final delay \hat{τ}ₚ and final Doppler shift \hat{ν}ₚ for pth path, \hat{γ}ₚ can be reconstructed. Using information about pilot signals 202a-d such as their delay and Doppler locations and pilot symbols xₙ_{ₐ}, n∈{1, 2, . . . , N_{T}} vector can be generated that comprises a pilot signal at vectorized pilot location corresponding to nth transmit antenna, while remaining entries being zero.

Using \hat{γ}ₚ, p∈{1, 2, . . . , P} and xₙ_{ₐ}, n∈{1, 2, . . . , N_{T}}, the dictionary matrix \hat{ψ} can be generated as per equation (29) mentioned above.

The received signal for the set of integer Doppler positions corresponding to received pilot signal Xa-d at each receiver antenna 104a-r are depicted as

$${Y}_{a}^{DD} = [ {y}_{1}^{a} , {y}_{2}^{a} , ... , {y}_{{N}_{R}}^{a} ] .$$

The channel gain matrix ‘H’ of equation (23) can be determined based on channel estimates based on LMMSE estimation as per equation (34) below.

$$\hat{H} = {( {\hat{ψ}}^{H} \hat{ψ} + {N}_{0} {I}_{{N}_{T} P} )}^{- 1} {\hat{ψ}}^{H} {Y}_{a}^{DD} \qquad ( 34 )$$

Wherein Yₐ^{DD} is pilot spread positions at each receive antenna 104a-r;
\hat{ψ} is dictionary matrix;
\hat{ψ}^{H} is Hermitian of the dictionary matrix.

Hence, after estimating channel gains Ĥ of different channel paths between each transmitter antenna 102a-n and the receiver antenna 104a-r, overall MIMO-OTFS channel matrix Ĥ_{DD} is built. Thus, the channel matrix determination module 406 may determine the channel matrix based on the channel gain of the received communication signal and the final Doppler shift and the final delay of each of the plurality of channel paths and of the plurality of receiver antennas 104a-r as per equations (17), (20), (21).

The AoA determination module 408 may determine angle of arrival (θₚ) for the plurality of channel paths using channel reconstruction method as described in detail below. An array response vector may be determined based on a phase change or phase shift of the communication signal received by each of the plurality of receiver antennas 104a-r via each of the plurality of channel paths p₁₋₃. In an embodiment, since the receiver antennas 104a-r may be positioned at constant distance with respect to each other. Thus, the signal received at each of the plurality of receiver antennas 104a-r may have a constant phase change that depend upon AoA θₚ, that may be depicted using the array response vector a_{R}(θₚ).

Further the AoA determination module 408 may determine a covariance matrix of the received communication signal. In order to determine AoA using the covariance matrix (R), the received signal vector (y_{DD}) of size N_{R}MN×1 may be reshaped into matrix Y of size N_{R}×MN such that MN samples from each receive antenna are stacked in column wise as depicted using equations (35) below.

$$R = \frac{1}{M N} {\underbrace{\{ {\underbrace{Y}}_{{N}_{R} \times MN} {\underbrace{{Y}^{H}}}_{MN \times {N}_{R}} \}}}_{{N}_{R} \times {N}_{R}} \qquad ( 35 )$$

Eigen value decomposition (EVD) may be performed on the covariance matrix (R) to get N_{R} eigen values and for each eigen value a corresponding eigen vector of size N_{R}×1.

If there are P (N_{R}>P) targets, then P number of signals are received from P paths at the receiver. Hence, out of N_{R} eigen values, P highest eigen values may correspond to signal subspace and remaining N_{R}−P eigen values may correspond to noise subspace.

Hence, after EVD, the covariance matrix is written as per equation (36) below.

$$R = {U}_{S} {Λ U}_{S}^{H} + {U}_{N} {Λ U}_{N}^{H} \qquad ( 36 )$$

Wherein Uₛ=[u₁, u₂, . . . , u_{P}] is an N_{R}×P signal subspace matrix comprising eigen vectors corresponding to P highest eigen values and Uₙ=[u_{P+1}, u_{P+2}, . . . , u_{N}_{_{R}}] represents noise subspace matrix of size N_{R}×N_{R}−P comprising eigen vectors of remaining N_{R}−P eigen values.

A diagonal matrix comprising P highest eigen values is determined as per equation (37) below. Further, a diagonal matrix comprising remaining N_{R}−P eigen values is determined as per equation (38).

$${Λ}_{S} = diag {\underbrace{\{ {e}_{1} , {e}_{2} , … , {e}_{P} , 0 , 0 , … , 0 \}}}_{{N}_{R}} \qquad ( 37 )$$

$${Λ}_{N} = diag {\underbrace{\{ 0 , 0 , … , 0 , {e}_{P + 1} , {e}_{P + 2} , … , {e}_{{N}_{R}} , \}}}_{{N}_{R}} \qquad ( 38 )$$

Further, Angle of arrival (AoA) can be estimated using equation (39) below.

$$[ {\hat{θ}}_{1} , {\hat{θ}}_{2} , … , {\hat{θ}}_{P} ] = arg {min}_{θ} \vert {a}_{R}^{H} ( θ ) {U}_{n} {U}_{n}^{H} {a}_{R} ( θ ) \vert \qquad ( 39 )$$

Analogously, direction angle estimation may also be represented in terms of its reciprocal to obtain peaks in Spatial noise spectrum determined using equation (40) below.

$${P}_{noise} = \frac{1}{\vert {a}^{H} ( θ ) {U}_{n} {U}_{n}^{H} a ( θ ) \vert} \qquad ( 40 )$$

FIG. 5 illustrates an exemplary graph 500 depicting a plot of Angle of arrival (AoA) vs noise spatial spectrum, in accordance with an exemplary embodiment of the present disclosure. AoAs of each of the communication signals for each of the plurality of channel paths may be determined based on the spatial noise spectrum determined for the received communication signals by each of the plurality of receiver antennas (104a-r). The noise spatial spectrum determined based on above equation (40) for θ between 0 degrees to 90 degrees. The angles at which peaks are determined may be determined as corresponding AoA for the detected channel paths. As depicted in the graph 500, four peaks depict that four channel paths exist with AoA θ₁-θ₄.

Referring back to FIG. 4, the sensing module 410 may determine a bistatic range

$$( {R}_{UE \to T \to BS}^{p} )$$

and a relative velocity of each of the plurality of channel paths caused by the plurality of targets 106-110 based on the estimated channel characteristics, the final Doppler shift and the final delay of each of the plurality of channel paths and of the plurality of receiver antennas 104a-r. The sensing module 410 may determine a bistatic range based on the estimated final delay using the concepts of bistatic radar. It is to be noted that bistatic range of the target is the combined distance between UE to target

$$( {R}_{UE \to T}^{p} )$$

and distance between target to UE

$$( {R}_{T \to BS}^{p} )$$

compared with line of sight (LoS) distance between BS 103 and UE 102, p is target index representing targets 106-110 in the environment 100. It is to be noted that for stationary targets 106 in the environment 100, final Doppler shift will be zero.

Bi-static range of different targets 106-110 is evaluated by BS 103 based on final delay estimates using equation (41), (42) below.

$${R}_{UE \to T \to B S}^{p} = {R}_{UE \to T}^{p} + {R}_{T \to BS}^{p} - L \qquad ( 41 )$$

$${R}_{UE \to T \to B S}^{p} = {\hat{τ}}_{p} {\underbrace{{τ}_{res} C}}_{{R}_{res}} = \frac{{\hat{τ}}_{p}}{M Δ f} C \qquad ( 42 )$$

where

$${R}_{UE \to T \to BS}^{p}$$

is the bi-static range,

$${R}_{UE \to T}^{p}$$

is range from UE to pth target,

$${R}_{T \to BS}^{p}$$

is range from a target 106-110 to the BS 103 and L is line of sight (LoS) distance between the BS 103 and the UE 102. τᵣₑₛ is unit delay resolution,

$$\frac{1}{M Δ f} .$$

It is assumed that Los distance BS 103 and UE 102 is known by the BS based on the initial synchronization process between BS and UE. The range resolution (Rᵣₑₛ) can be calculated as per equation (43) as below:

$${R}_{res} = {τ}_{res} c \qquad ( 43 )$$

\hat{τ}ₚ is the estimated final delay of the Pth path caused by a pth target, here M represents number of delay bins (number of subcarriers) for each pilot 202a-n,
Δf represents OFDM subcarrier spacing and C is the speed of the wave (speed of light=3×10⁸ m/sec).

As bistatic range is the combined distance from UE 102 to target 106-100 and from target 106-110 to BS 103, The individual ranges from each of the targets 106-110 to BS 103 can be determined based on bistatic radar concepts using equation (44) below.

$${R}_{T \to BS}^{p} = \frac{{( {R}_{UE \to T}^{p} + {R}_{T \to BS}^{p} )}^{2} - {L}^{2}}{2 ( {R}_{UE \to T}^{p} + {R}_{UE \to T}^{p} + L sin {θ}_{p} )} \qquad ( 44 )$$

where

$${R}_{UE \to T}^{p} and {R}_{T \to BS}^{p}$$

indicates the range from a transmitter antenna 102 to target 106-110 and from the target 106-110 to BS 103 via the Pth path, and θₚ is the AoA of the Pth path caused by pth target.

AoA determination module 408 may evaluate AoA (θₚ) using MUSIC algorithm presented in equations (39) and (40). Using AoA estimate θₚ, individual range

$${R}_{T \to BS}^{p}$$

can be estimated using equation (42). Once

$${R}_{T \to BS}^{p}$$

is calculated using equation (44),

$${R}_{UE \to T}^{p}$$

can also be calculated using

$${R}_{UE \to T \to BS}^{p} = {R}_{UE \to T}^{p} + {R}_{T \to BS}^{p} - L$$

formula of equation (41).

The sensing module 410 may determine relative velocity of the targets 106-110 using Doppler velocity resolution vᵣₑₛ of the targets 106-110. The sensing module 410 may determine Doppler velocity resolution (Vᵣₑₛ) as given by equation (45) below.

$${V}_{res} = \frac{{ν}_{res} C}{{f}_{c}} = \frac{C}{{f}_{c} NT} \qquad ( 45 )$$

Wherein Doppler resolution νᵣₑₛ is unit Doppler resolution,

$$\frac{1}{NT} ,$$

and C speed of light and f_{c} is the carrier frequency. Relative velocity of the target causing Pth channel path is estimated using Doppler velocity resolution and estimated final Doppler shift using equation (46) below.

$${V}^{p} = {\hat{ν}}_{p} {V}_{res} = \frac{{\hat{ν}}_{p} c}{{f}_{c} NT} \qquad ( 46 )$$

Wherein \hat{ν}ₚ is estimated final Doppler shift of the pth path as determined earlier, f_{c} is carrier frequency Accordingly, the relative velocity of the target causing the Pth path may be determined as per equation (46). Based on methodology described above doppler velocity and ranges of all the targets 106-110 may be determined based on the channel estimation performed at channel characteristics determination module 404.

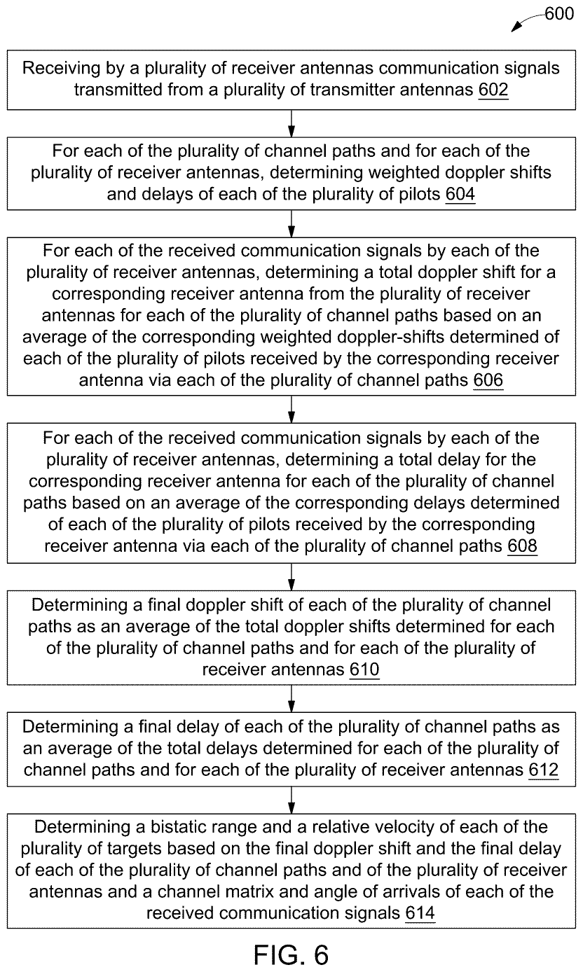

FIG. 6 illustrates a flow diagram 600 depicting methodology of performing integrated sensing and communication in a wireless communication environment 100, in accordance with an embodiment of the present disclosure. The methodology may be implemented by various modules 402-410 of the base station 103. At step 602, the plurality of receiver antennas 104a-r of the BS 103 may receive communication signals transmitted from a plurality of transmitter antennas 102a-n. It is to be noted that each of the communication signals may be received via a plurality of channel paths caused by a plurality of targets 106-110 in the wireless communication environment 100. Further, each of the received communication signals may include a plurality of pilots Xa-n each of which may uniquely correspond to pilots 202a-n transmitted by the plurality of transmitter antennas 102a-n.

For each of the plurality of channel paths and for each of the plurality of receiver antennas 104a-r, at step 604, the BS 103 may determine weighted Doppler-shifts and delays of each of the pilots 202a-n in each of the received communication signals based on representation of the received communication signals in a delay-Doppler domain. It is to be noted that the weighted Doppler-shifts of each of the plurality of pilots 202a-n may be determined based on a weighted average of a set of Doppler values corresponding to a set of integer Doppler positions of each of the plurality of pilots. For each of the received communication signals by each of the plurality of receiver antennas 104a-r, at step 606, the BS 103 may determine a total Doppler shift for a corresponding receiver antenna 104a from the plurality of receiver antennas 104a-r for each of the plurality of channel paths based on an average of the corresponding weighted Doppler-shifts of each of the plurality of pilots Xa-n received by the corresponding receiver antenna 104a via each of the plurality of channel paths. Further, for each of the received communication signals by each of the plurality of receiver antennas 104a-r, at step 608, the BS 103 may determine a total delay for the corresponding receiver antenna 104a based on an average of the corresponding delays determined for each of the plurality of pilots Xa-n received by the corresponding receiver antenna 104a via each of the plurality of channel paths. Further, at step 610, the BS 103 may determine a final Doppler shift of each of the plurality of channel paths as an average of the total Doppler shifts determined for each of the plurality of channel paths and for each of the plurality of receiver antennas 104a-r. Further, at step 612, the BS 103 may determine a final delay of each of the plurality of channel paths as an average of the total delays determined for each of the plurality of channel paths and for each of the plurality of receiver antennas 104a-r.

At step 614, the base station 103 may determine a bistatic range and a relative velocity of each of the plurality of the targets 102a-n based on based on the final Doppler shift and the final delay of each of the plurality of channel paths and of the plurality of receiver antennas 104a-r and a channel matrix and angle of arrivals for the plurality of channel paths for each of the received communication signals.

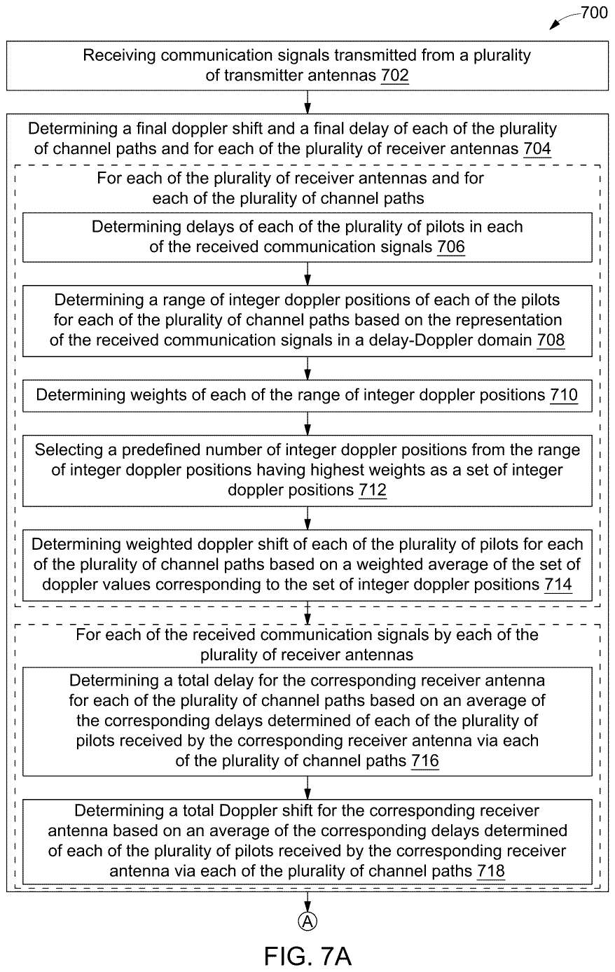

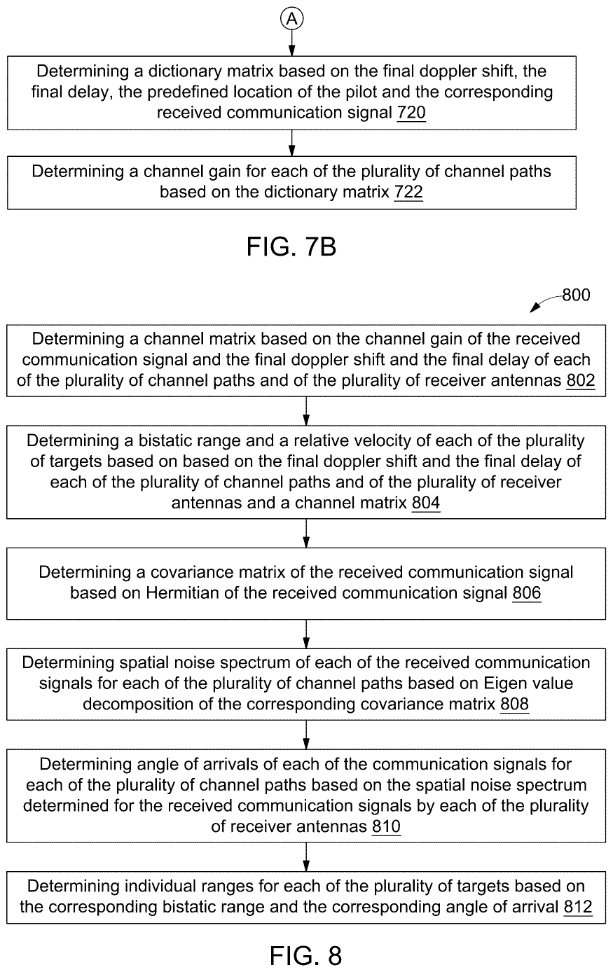

FIG. 7A and FIG. 7B illustrates a detailed flow diagram 700 of estimating channel characteristics of plurality of channel paths in wireless communication environment 100, in accordance with an embodiment of the present disclosure. The steps of the flow diagram 700 may be performed by the modules 402-410 of the BS 103. At step 702, each of the plurality of receiver antennas 104a-r of the base station 103 may receive communication signals transmitted from a plurality of transmitter antennas 102a-d. It is to be noted that each of the communication signals may be received via a plurality of channel paths caused by a plurality of targets 106-110 in the wireless communication environment 100. Further, each of the received communication signals may include a plurality of pilots Xa-n each of which may uniquely correspond to the pilots 202a-n transmitted by the plurality of transmitter antennas 102a-n For each of the plurality of channel paths and for each of the plurality of receiver antennas 104a-r, at step 704, the BS 103 may determine a final Doppler shift and a final delay of each of the plurality of channel paths P₁₋₃ based on sub-steps 706-716. In an embodiment, for each of the plurality of channel paths and for each of the plurality of receiver antennas 104a-r, at step 706, delays of each of the pilots 202a-d in each of the received communication signals based on representation of the received communication signals in a delay-Doppler domain.

At step 708, the BS 103 may determine a range of integer doppler positions of each of the pilots (202a-n) for each of the plurality of channel paths based on the representation of the received communication signals in a delay-Doppler domain. The range of integer Doppler positions may be determined as integer doppler positions for which received signal power of a corresponding pilot from the plurality of pilots (202a-n) is greater than a threshold signal power. At step 710, the BS 103 may determine weights of each of the range of integer Doppler positions based on a ratio of the signal power of the corresponding pilot Xa-d received for a corresponding integer Doppler position from the range of integer Doppler positions and a norm value of the signal power of each of plurality of pilots (202a-n) received for the range of integer Doppler positions. At step 712, the BS 103 may select a predefined number of integer doppler positions from the range of integer doppler positions having highest weights as a set of integer doppler positions. At step 714, weighted Doppler-shifts for each of the plurality of channel paths p₁₋₃ and for each of the pilots Xa-b may be determined based on a weighted average of the set of Doppler values corresponding to the selected set of integer doppler positions of each of the pilots Xa-d and the corresponding determined weights of the selected set of integer Doppler positions of each of the pilots Xa-d. For each of the received communication signals by each of the plurality of receiver antennas 104-a-r, at step 716, the BS 103 may determine a total delay for the corresponding receiver antenna 104a for each of the plurality of channel paths P₁₋₃ based on an average of the corresponding delays determined of each of the plurality of pilots Xa-n received by the corresponding receiver antenna 104a via each of the plurality of channel paths P₁₋₃. Further, for each of the received communication signals by each of the plurality of receiver antennas 104-a-r, at step 718, the BS 103 may determine a total Doppler shift for a corresponding receiver antenna 104a from the plurality of receiver antennas 104a-r for each of the plurality of channel paths p₁₋₃ based on an average of the corresponding weighted Doppler-shifts determined of each of the plurality of pilots Xa-n received by the corresponding receiver antenna 104a via each of the plurality of channel paths.

Further, the BS 103 at step 704 may determine the final delay of each of the plurality of channel paths P₁₋₃ as an average of the total delays determined for each of the plurality of channel paths P₁₋₃ and for each of the plurality of receiver antennas 104a-r. Further, the BS 103 at step 704 may determine the final Doppler shift of each of the plurality of channel paths P₁₋₃ as an average of the total Doppler shifts determined for each of the plurality of channel paths P₁₋₃ and for each of the plurality of receiver antennas 104a-r.

At step 720, the BS 103 may determine a dictionary matrix based on the final Doppler shift, the final delay, the predefined location of the pilots 202a-n and the corresponding received communication signal. At step 722, the BS 103 may determine a channel gain for each of the plurality of channel paths based on the dictionary matrix.

FIG. 8 illustrates a flow diagram 800 depicting methodology of sensing targets in the wireless communication environment based on channel estimation as described in flow diagram 700 of FIG. 7. The steps of the methodology of the flow diagram 800 may be performed by the modules 402-414 of the BS 103 in continuation to the steps 702-722. At step 802, the BS 103 may determine a channel matrix based on the channel gain of the received communication signal and the final Doppler shift and the final delay of each of the plurality of channel paths P₁₋₃ and of the plurality of receiver antennas 104a-r. At step 804, the BS 103 may determine a bistatic range and a relative velocity of each of the plurality of targets 106-110 based on the final Doppler shift and the final delay of each of the plurality of channel paths P₁₋₃ and of the plurality of receiver antennas 104a-r and a channel matrix of each of the received communication signals.

At step 806, the BS 103 may determine a covariance matrix of each of the received communication signals based on Hermitian of each of the received communication signals. At step 808, the BS 103 may determine spatial noise spectrum of each of the received communication signals for each of the plurality of channel paths P₁₋₃ based on Eigen value decomposition of the corresponding covariance matrix. At step 810, the BS 103 may determine the angle of arrivals of each of the communication signals for each of the plurality of channel paths P₁₋₃ based on the spatial noise spectrum determined for the received communication signals by each of the plurality of receiver antennas 104a-r. At step 812, the BS 103 may determine individual ranges of each of the plurality of targets 106-110 based on the corresponding bistatic range and the corresponding angle of arrival determined for each target for its corresponding channel path.

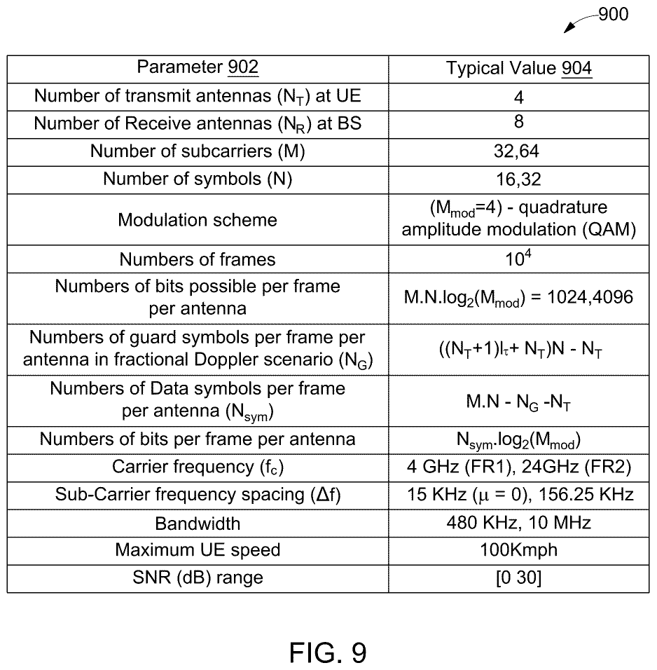

FIG. 9 illustrates an exemplary table 900 depicting a plurality of simulation parameters 902 and their estimated values 904 to evaluate performance of channel estimation using the methodology of present disclosure and with respect to actual channel. Performance of channel estimation based on simulation results has been evaluated by determining normalized mean square error (NMSE) between estimated channel and actual channel based on simulation parameters using equation (46) mentioned below.

$$NMSE = \frac{{‖ {\hat{H}}_{DD} - {H}_{DD} ‖}^{2}}{{‖ {\hat{H}}_{DD} ‖}^{2}} \qquad ( 46 )$$

Wherein H_{DD} is original effective DD channel matrix and Ĥ_{DD} estimated DD channel matrix.

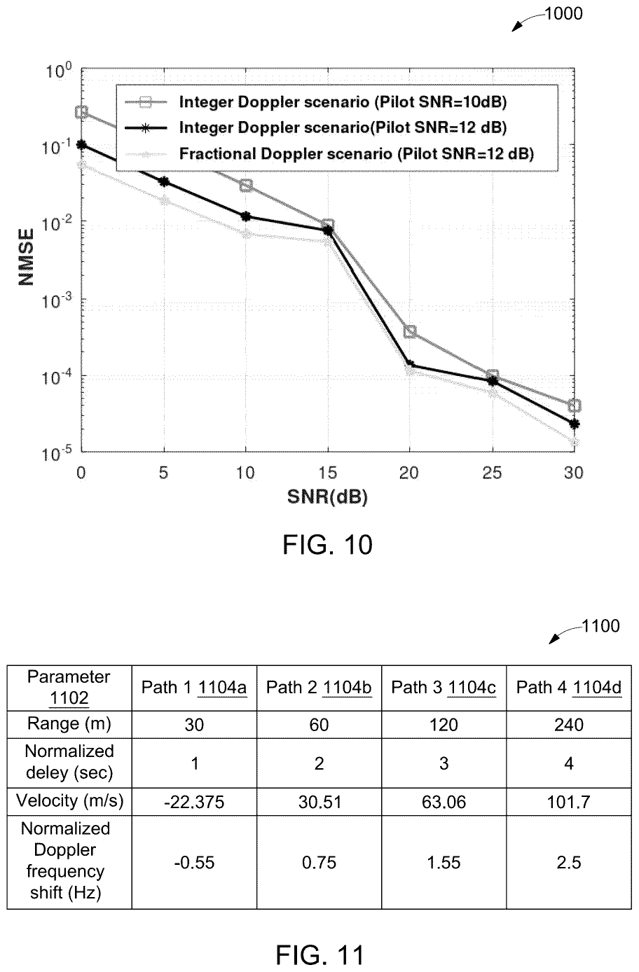

FIG. 10 illustrates a graph 1000 depicting a plot of NMSE vs. signal noise ration graph (SNR) for OTFS system determined based on simulation parameters N_{T}=8, N_{R}=4, f_{c}=4 GHz, Δf=15 KHz, M=32, N=16, M_{mod}=4-QAM as per FIG. 9. Graph 1000 also depicts NMSE for integer Doppler scenario (final Doppler shift is integer multiple of unit Doppler resolution) and fractional Doppler scenario. It is observed from the graph 1000 that NMSE tends to decrease with increase in SNR values. It is observed that NMSE in both integer Doppler scenario and fractional Doppler scenario is similar. It is also observed that NMSE tends to decrease for increasing pilot power (higher pilot SNR). It can be seen that NMSE of 10⁻⁴ is achieved at an SNR of 23 dB, 22 dB for integer Doppler scenario and fractional Doppler scenario for considered pilot SNR of 12 db. Thus, it may be concluded that lower NMSE performance at 12 dB pilot power depicts good estimation of the sensing parameter (range and velocity) based on the embodiments of the current disclosure when compared to actual sensing parameters.

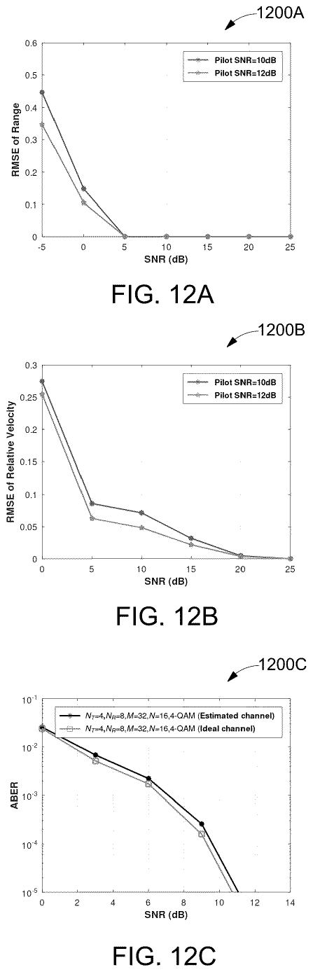

FIG. 11 illustrates an exemplary table 1100A depicting estimated target parameters 1102 for each of the plurality of channel paths 1104a-d, in accordance with the embodiments of FIG. 9. Parameters include 1102 for each of the paths 1104a-d include the target parameters (range and velocity) and normalized delay and Doppler shift as per delay resolution (0.1 μsec), range resolution (30 m), and Doppler resolution (4.88 KHz) and velocity resolution (40.6833 m/sec). Now referred to FIG. 12A a graph 1200A representing root mean square error (RMSE) of range vs. SNR of the received communication signal for OTFS system is illustrated, in accordance with the embodiments of FIG. 11. The graph 1200A is determined when N_{T}=8, N_{R}=4, f_{c}=24 GHz, Δf=156 KHz, M=64, N=32, M_{mod}=4-QAM. It is to be noted that RMSE of bistatic range is calculated for different SNR values of the pilot using equation (47) below. It may be observed that RMSE error is zero for SNR values greater than 5 dB This indicates that range values estimated using the methodology of present disclosure are accurate. At low SNR values i.e., 0 and 5 dB, there is slight increase in error due to false detection of paths because of noise, but for low to high SNR values, range is accurately estimated resulting in zero RMSE of range. It is also observed that increasing pilot power (higher pilot SNR) will result in better range estimation and reduction of RMSE.

$${RMSE}_{Range} = \sqrt{{\sum }_{p = 1}^{\hat{P}} \frac{{( {\hat{R}}_{T \to BS}^{p} - {R}_{T \to BS}^{p} )}^{2}}{\hat{P}}} \qquad ( 47 )$$

Wherein

$${R}_{T \to BS}^{p}$$

is actual range from pth target to BS and

$${\hat{R}}_{T \to BS}^{p}$$

is the estimated range from pth target to BS.
\hat{P} is number of detected paths.

Now referring to FIG. 12B a graph 1200B representing root mean square error (RMSE) of relative velocity vs. SNR of the received communication signal for OTFS system is illustrated, in accordance with the embodiments of FIG. 11. The root mean square error (RMSE) is determined between estimated velocity determined based on the methodology of the present disclosure and actual velocity of the targets using equation (48) below when N_{T}=8, N_{R}=4, f_{c}=24 GHz, Δf=156 KHz, M=64, N=32, M_{mod}=4-QAM. It is to be noted that RMSE of estimated velocity of the target is calculated for different SNR values of the pilot. It observed that due to fractional Doppler conditions, error increases for low SNR values. For high SNR values, velocity of targets may be estimated accurately resulting in decrease of RMSE as shown in graph 1200B. It is also observed that increasing pilot power (higher pilot SNR) will result in better estimation of velocity and reduction of RMSE.

$${RMSE}_{Velocity} = \sqrt{{\sum }_{p = 1}^{\hat{P}} \frac{{( {\hat{V}}_{p} - {V}_{p} )}^{2}}{\hat{P}}} \qquad ( 48 )$$

Wherein Vₚ is the actual velocity of the target causing p th path and \hat{V}ₚ is estimated relative velocity of the target causing pth path;
\hat{P} is number of detected paths.

FIG. 12C illustrates a graph 1200C depicting average bit error rate (ABER) vs. SNR of the received communication signal, in accordance with the simulation parameters considered in the embodiments of FIG. 9. The Simulation process is as follows: Bits are randomly generated and converted to symbols using M_{mod}=4-quadrature amplitude modulation (QAM) scheme. Generated symbols are arranged in DD data frame and then OTFS modulation is employed before transmission through transmit antennas of the UE 102. DD Channel matrix is generated based on targets considered in environment (100) causing channel paths each with unique delay and Doppler values and randomly generated complex Gaussian channel gains for each channel path. Transmitted signal is filtered through generated channel matrix. At the BS 103, channel estimation based on proposed methodology is performed to reconstruct the channel matrix. Using the estimated channel matrix, OTFS signals can be demodulated. Demodulated OTFS symbols are then converted to bits using QAM demodulation. Finally, transmitted bits (at the UE 102) and received bits (at the BS 103) are compared for any errors to calculate bit error rate (BER). BER is a ratio of a number of bits in error to total number of bits transmitted. This process is repeated for 10⁴ frames for various received signal SNR values and resulting BER values are averaged to obtain average bit error rate (ABER).

Graph 1200C depicts ABER performance of 8×4 MIMO-OTFS (f_{c}=4 GHz, Δf=15 KHz, M=32, N=16, M_{mod}=4-QAM) for channel estimated using proposed channel estimation scheme of present disclosure in comparison with the actual ideal channel. It is observed from graph 1200C that the BER performance of MIMO-OTFS system using estimated channel is very close to the actual channel with less performance degradation.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps bring an improvement in the functioning of the device itself as the claimed steps provide a technical solution to a technical problem.

The specification describes the method and system of detecting a plurality of targets in wireless communication. The current disclosure is focused on performing channel estimation and sensing through common OTFS waveform without changing the existing communication infrastructure. Proposed channel estimation scheme may work efficiently in integer doppler as well as fractional Doppler scenarios, which in turn improves the sensing and communication performances. Through the estimated channel parameters, range, Doppler velocity and AoA of targets can be estimated with good accuracy. The illustrated steps are set out to explain the exemplary embodiments shown, and it should be anticipated that ongoing technological development will change the way particular functions are performed. These examples are presented herein for purpose of illustration, and not limitation of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. It is intended that the disclosure and examples be considered as exemplary only, with a true scope of disclosed embodiments being indicated by the following claims.

What is claimed is:

1. A method of performing integrated sensing and communication in a wireless communication environment, comprising:
receiving, by a plurality of receiver antennas of a base station (BS), communication signals transmitted from a plurality of transmitter antennas,
wherein each of the communication signals are received via a plurality of channel paths caused by a plurality of targets in the wireless communication environment;
wherein each of the received communication signals comprise a plurality of pilots each uniquely corresponding to the plurality of transmitter antennas;
for each of the plurality of channel paths and for each of the plurality of receiver antennas:
determining, by the BS, weighted Doppler-shifts and delays of each of the plurality of pilots in each of the received communication signals based on representation of the received communication signals in a delay-Doppler domain,
wherein the weighted doppler-shifts of each of the plurality of pilots are determined based on a weighted average of a set of Doppler values corresponding to a set of integer Doppler positions of each of the plurality of pilots;
for each of the received communication signals by each of the plurality of receiver antennas:
determining, by the BS, a total Doppler shift for a corresponding receiver antenna from the plurality of receiver antennas for each of the plurality of channel paths based on an average of the corresponding weighted Doppler-shifts determined for each of the plurality of pilots received by the corresponding receiver antenna via each of the plurality of channel paths;
determining, by the BS, a total delay for the corresponding receiver antenna for each of the plurality of channel paths based on an average of the corresponding delays of each of the plurality of pilots received by the corresponding receiver antenna via each of the plurality of channel paths;
determining, by the BS, a final Doppler shift of each of the plurality of channel paths as an average of the total Doppler shifts determined for each of the plurality of channel paths and for each of the plurality of receiver antennas;
determining, by the BS, a final delay of each of the plurality of channel paths as an average of the total delays determined for each of the plurality of channel paths and for each of the plurality of receiver antennas; and
determining, by the BS, a bistatic range and a relative velocity of each of the plurality of targets based on the final Doppler shift and the final delay of each of the plurality of channel paths and of the plurality of receiver antennas and a channel matrix and angle of arrivals for plurality of channel paths.

2. The method of claim 1, comprising:
determining, by the BS, a covariance matrix of each of the received communication signals based on Hermitian of each of the received communication signals;
determining, by the BS, spatial noise spectrum of each of the received communication signals based on Eigen value decomposition of the corresponding covariance matrix; and
determining, by the BS, the angle of arrivals for the plurality of channel paths based on the spatial noise spectrum determined for the received communication signals by each of the plurality of receiver antennas.

3. The method of claim 2, comprising:
determining, by the BS, individual ranges for each of the plurality of targets based on the corresponding bistatic ranges and the corresponding angle of arrivals.

4. The method of claim 1, wherein each of the plurality of pilots are provided at a predefined position of a guard band of each of the communication signals in order to uniquely correspond to the corresponding transmitter antenna from the plurality of transmitter antennas.

5. The method of claim 4, comprising:
determining, by the BS, a dictionary matrix based on the final Doppler shift, the final delay, the predefined location of the pilot and the corresponding received communication signal;
determining, by the BS, a channel gain for each of the plurality of channel paths based on the dictionary matrix; and
determining, by the BS, the channel matrix based on the channel gain of the received communication signal and the final Doppler shift and the final delay of each of the plurality of channel paths and of the plurality of receiver antennas.

6. The method of claim 1, wherein determining the weighted Doppler shift of each of the pilots for each of the plurality of channel paths comprises:
determining, by the BS, a range of integer doppler positions for which received signal power of a corresponding pilot from the plurality of pilots is greater than a threshold signal power;
determining, by the BS, weights of each of the range of integer doppler positions based on a ratio of the received signal power of the corresponding pilot for a corresponding integer doppler position from the range of integer doppler positions and a norm value of the signal powers of each of plurality of pilots received for each of the range of integer doppler positions; and
selecting a predefined number of integer doppler positions from the range of integer doppler positions having highest weights as the set of integer doppler positions.

7. A wireless communication system for performing integrated sensing and communication, the system comprising:
a base station (BS) comprising a plurality of receiver antennas,
wherein the BS is configured to:
receive, via the plurality of receiver antennas, communication signals transmitted by a plurality of transmitter antennas,
wherein each of the communication signals are received via a plurality of channel paths caused by a plurality of targets; and
wherein each of the received communication signals comprise a plurality of pilots each uniquely corresponding to the plurality of transmitter antennas;
for each of the plurality of channel paths and for each of the plurality of receiver antennas:
determine weighted Doppler-shifts and delays of each of the pilots in each of the received communication signals,
wherein the weighted Doppler-shifts of each of the plurality of pilots are determined based on a weighted average of a set of Doppler values corresponding to a set of integer Doppler positions of each of the plurality of pilots;
for each of the received communication signals by each of the plurality of receiver antennas:
determine a total Doppler shift for a corresponding receiver antenna from the plurality of receiver antennas based on an average of the corresponding weighted Doppler shifts determined of each of the plurality of pilots received by the corresponding receiver antenna via each of the plurality of channel paths;
determine a total delay for the corresponding receiver antenna based on an average of the corresponding delays determined of each of the plurality of pilots received by the corresponding receiver antenna via each of the plurality of channel paths;
determine a final Doppler shift of each of the plurality of channel paths as an average of the total Doppler shift determined for each of the plurality of channel paths and for each of the plurality of receiver antennas;
determine a final delay of each of the plurality of channel paths as an average of the total delay determined for each of the plurality of channel paths and for each of the plurality of receiver antennas; and
determine a bistatic range and a relative velocity of each of the plurality of targets based on the final Doppler shift and the final delay of each of the plurality of channel paths and of the plurality of receiver antennas and a channel matrix and angle of arrivals of each of the received communication signals for each of the plurality of channel paths.

8. The wireless system of claim 7, wherein the BS is configured to:
determine a covariance matrix of each of the received communication signals based on Hermitian of each of the received communication signals;
determine spatial noise spectrum of each of the received communication signals based on Eigen value decomposition of the corresponding covariance matrix; and
determine the angle of arrival of each of the communication signals for each of the plurality of channel paths based on the spatial noise spectrum determined for the received communication signals by each of the plurality of receiver antennas.

9. The wireless system of claim 8, wherein by the BS is configured to:
determine individual ranges for each of the plurality of targets based on the corresponding bistatic ranges and the corresponding angle of arrivals.

10. The wireless system of claim 7, wherein each of the plurality of pilots are provided at a predefined position of a guard band of each of the communication signals in order to uniquely correspond to the corresponding transmitter antenna from the plurality of transmitter antennas.

11. The wireless system of claim 10, wherein the BS is configured to:
determine a dictionary matrix based on the final Doppler shift, the final delay, the predefined location of the pilot and the corresponding received communication signal;
determine a channel gain for each of the plurality of channel paths based on the dictionary matrix;
determine the channel matrix based on the channel gain of the received communication signal and the final Doppler shift and the final delay of each of the plurality of channel paths and of the plurality of receiver antennas.

12. The wireless system of claim 7, wherein the BS is configured to determine the weighted Doppler shift of each of the pilots for each of the plurality of channel paths based on:
determination of a range of integer Doppler positions for which received signal power of a corresponding pilot from the plurality of pilots is greater than a threshold signal power;
determination of weights of each of the range of integer Doppler positions based on a ratio of the received signal power of the corresponding pilot for a corresponding integer Doppler position and a norm value of the signal power of each of plurality of pilots received for each of the range of integer Doppler positions,
wherein a predefined number of integer doppler positions from the range of integer doppler positions having highest weights are selected as the set of integer doppler positions.

13. A base station for performing integrated sensing and communication in a wireless communication environment, wherein the base station is configured to:
receive, via a plurality of receiver antennas of the BS, communication signals transmitted by a plurality of transmitter antennas,
wherein each of the communication signals are received via a plurality of channel paths caused by a plurality of targets in the wireless communication environment;
wherein each of the received communication signals comprise a plurality of pilots each uniquely corresponding to the plurality of transmitter antennas;
for each of the plurality of channel paths and for each of the plurality of receiver antennas:
determine weighted Doppler-shifts and delays of each of the pilots in each of the received communication signals,
wherein the weighted Doppler-shifts of each of the plurality of pilots are determined based on a weighted average of a set of Doppler values corresponding to a set of integer Doppler positions of each of the plurality of pilots;
for each of the received communication signals by each of the plurality of receiver antennas:
determine a total Doppler shift for a corresponding receiver antenna from the plurality of receiver antennas based on an average of the corresponding weighted Doppler shifts determined of each of the plurality of pilots received by the corresponding receiver antenna via each of the plurality of channel paths;
determine a total delay for the corresponding receiver antenna based on an average of the corresponding delays determined of each of the plurality of pilots received by the corresponding receiver antenna via each of the plurality of channel paths;
determine a final Doppler shift of each of the plurality of channel paths as an average of the total Doppler shift determined for each of the plurality of channel paths and for each of the plurality of receiver antennas;
determine a final delay of each of the plurality of channel paths as an average of the total delay determined for each of the plurality of channel paths and for each of the plurality of receiver antennas; and
determine a bistatic range and a relative velocity of each of the plurality of targets based on the final Doppler shift and the final delay of each of the plurality of channel paths and of the plurality of receiver antennas and a channel matrix and angle of arrivals of each of the received communication signals for each of the plurality of channel paths.

14. The base station of claim 13, further configured to:
determine a covariance matrix of each of the received communication signals based on Hermitian of each of the received communication signals;
determine spatial noise spectrum of each of the received communication signals based on Eigen value decomposition of the corresponding covariance matrix; and
determine the angle of arrivals for the plurality of channel paths based on the spatial noise spectrum determined for the received communication signals by each of the plurality of receiver antennas.

15. The base station of claim 14, further configured to:
determine individual ranges for each of the plurality of targets based on the corresponding bistatic ranges and the corresponding angle of arrivals.

16. The base station of claim 13, wherein each of the plurality of pilots are provided at a predefined position of a guard band of each of the communication signals in order to uniquely correspond to the corresponding transmitter antenna from the plurality of transmitter antennas.

17. The base station of claim 16, further configured to:
determine a dictionary matrix based on the final Doppler shift, the final delay, the predefined location of the pilot and the corresponding received communication signal;
determine a channel gain for each of the plurality of channel paths based on the dictionary matrix; and
determine the channel matrix based on the channel gain of the received communication signal and the final Doppler shift and the final delay of each of the plurality of channel paths and of the plurality of receiver antennas.

18. The base station of claim 13, wherein the weighted Doppler shift of each of the pilots for each of the plurality of channel paths is determined based on:
determination of a range of integer doppler positions for which received signal power of a corresponding pilot from the plurality of pilots is greater than a threshold signal power;
determination of weights of each of the range of integer doppler positions based on a ratio of the received signal power of the corresponding pilot for a corresponding integer doppler position from the range of integer doppler positions and a norm value of the signal powers of each of plurality of pilots received for each of the range of integer doppler positions; and
selection of a predefined number of integer doppler positions from the range of integer doppler positions having highest weights as the set of integer doppler positions.
